(19) United States
(12) Patent Application Publication
(10) Pub. No.: US 2026/0012559 A1
(43) Pub. Date: Jan. 8, 2026

(54) MOBILE PROJECTOR AND METHOD FOR OPERATING MOBILE PROJECTOR

(71) Applicant: Samsung Electronics Co., Ltd., Suwon-si (KR)

(72) Inventors: Minhyo JUNG, Suwon-si (KR); Sehyun Kim, Suwon-si (KR); Donguk Kim, Suwon-si (KR); Yeonwoo Kim, Suwon-si (KR); Jongin Lee, Suwon-si (KR); Donghwa Jeong, Suwon-si (KR)

(73) Assignee: Samsung Electronics Co, Ltd., Suwon-si (KR)

(21) Appl. No.: 19/256,946

(22) Filed: Jul. 1, 2025

Related U.S. Application Data
(63) Continuation of application No. PCT/KR2025/007487, filed on May 30, 2025.

(30) Foreign Application Priority Data
Jun. 4, 2024 (KR) 10-2024-0072995

(51) Int. Cl. H04N 9/31; G06F 3/01; G06F 3/14; G06V 20/58; G06V 40/16

(52) U.S. Cl. CPC H04N 9/3173; G06F 3/017; G06F 3/1454; G06V 20/58; G06V 40/172

(57) ABSTRACT

A mobile projector device includes a drive assembly including at least one wheel, a transceiver, a projector, memory storing instructions, and at least one processor, where the instructions, when executed by the at least one processor, cause the mobile projector device to determine whether to set the mobile projector device as an extension display device associated with a source device, receive, through the transceiver and from the source device, information about an image based on determining to set the mobile projector device as the extension display device, determine a projection position of the mobile projector device for projecting the image based on position information about the source device, and control the projector to project the image while the mobile projector device is at the projection position.

### CROSS-REFERENCE TO RELATED APPLICATIONS

This application is a continuation of International Application No. PCT/KR2025/007487 designating the United States, filed on May 30, 2025, in the Korean Intellectual Property Receiving Office, which is based on and claims priority to Korean Patent Application No. 10-2024-0072995, filed on Jun. 4, 2024, in the Korean Intellectual Property Office, the disclosures of which are incorporated by reference herein in their entireties.

### BACKGROUND

### 1. Field

The disclosure relates to a mobile projector and a method for operating the mobile projector.

### 2. Description of Related Art

Robots have been developed in industrial sectors, such as manufacturing, and are being used as part of factory automation. Recently, new technologies have been studied to present various robots, such as medical surgical robots or military robots, and the use of robots is expanding not only in the industrial field but also in the home.

Mobile robots may autonomously move through a specific area and execute commands previously entered or received in real-time. Mobile robots may be used as cleaning robots, telepresence robots, or security robots, and have been developed for various purposes in various fields.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

The mobile robot may operate based on an operating system and receive various contents from a server on a network based on a communication function. The mobile robot may include a display and display the content provided from the server on the display. The mobile robot including the display may perform the display operation while moving. However, since the mobile robot is able to simply display content on the display, it may function only as a mobile display device, like a mobile terminal.

Common mobile robots do not include a projector. The projector may display screens of various sizes various positions and it may thus be utilized for various purposes as compared with a display having a fixed size. However, as mobile robots with a projector have not been considered or utilized, a need arises for developing one.

Additional aspects will be set forth in part in the description which follows and, in part, will be apparent from the description, or may be learned by practice of the presented embodiments.

According to an aspect of the disclosure, a mobile projector device may include a drive assembly including at least one wheel, a transceiver, a projector, memory storing instructions, and at least one processor, where the instructions, when executed by the at least one processor, cause the mobile projector device to determine whether to set the mobile projector device as an extension display device associated with a source device, receive, through the transceiver and from the source device, information about an image based on determining to set the mobile projector device as the extension display device, determine a projection position for projecting the image (e.g., a projection position of the mobile projector device for projecting the image) based on position information about the source device, and control the projector to project the image at the projection position (e.g., while the mobile projector device is at the projection position).

The instructions, when executed by the at least one processor, may further cause the mobile projector device to receive, through the transceiver and from the source device, a request message requesting to set the mobile projector device as the extension display device, determine whether a projection operation by the projector is being performed based on reception of the request message, based on determining that the projection operation is being performed, determine to not set the mobile projector device as the extension display device, and control the transceiver to transmit a reject message to the source device, and based on determining that the projection operation is not being performed, determine to set the mobile projector device as the extension display device and control the transceiver to transmit an accept message to the source device.

The instructions, when executed by the at least one processor, may further cause the mobile projector device to control the drive assembly to move the mobile projector device to the projection position.

The instructions, when executed by the at least one processor, may further cause the mobile projector device to, while at the projection position identify an area adjacent to the source device and control the projector to project the image to the identified area.

The mobile projector device may include a user interface (UI), and the instructions, when executed by the at least one processor, may further cause the mobile projector device to identify a control signal generated based on interaction with the UI, and based on the identified control signal, stop projecting the image and release the setting of the mobile projector device as the extension display device, where the identified control signal may include at least one instruction to project a different image or at least one instruction to move the mobile projector device.

The information about the image may include information about at least one of an image received in real-time by the source device, an image associated with an application executed on the source device, an image associated with a camera connected to the source device, and an image provided from a mobile terminal connected to the source device.

The mobile projector device may include a main body, a driver, a plurality of sensors, and at least one camera, and the instructions, when executed by the at least one processor, may further cause the mobile projector device to determine, by the plurality of sensors and/or the at least one camera, a presence or absence of an obstacle in a direction in which the image is projected, and based on determining the presence of the obstacle, control the driver to rotate the main body of the mobile projector device by a predetermined angle.

The mobile projector device may include a plurality of sensors and at least one camera, and the instructions, when executed by the at least one processor, may further cause the mobile projector device to determine, by a first sensor among the plurality of sensors, a presence or absence of a change in height at the projection position, based on determining the presence of the change in height, determine, by at least one of a second sensor among the plurality of sensors and the at least one camera, a presence or absence of a fall section at a position adjacent to the mobile projector device, the fall section indicating an area where the mobile projector device will fall, and based on determining the absence of the fall section, control the projector to project the image using a first projection method, and based on determining the absence of the change in height, control the projector to project the image using a second projection method, where the first projection method and the second projection method differ in projection distance or projection direction.

The instructions, when executed by the at least one processor, may further cause the mobile projector device to, based on determining the presence of the fall section, perform, by the at least one camera, a face recognition operation, determine whether a user's face is recognized based on the face recognition operation, and based on the user's face not being recognized, control the projector to project the image using the first projection method.

The instructions, when executed by the at least one processor, may further cause the mobile projector device to, based on determining the presence of the fall section, perform, by the at least one camera, a face recognition operation, determine whether a user's face is recognized based on the face recognition operation, and based on the user's face being recognized, determine, by the at least one camera and in a direction in which the user's face is recognized, whether the user's gesture is detected, based on the user's gesture being detected, identify whether the user's gesture is a first gesture or a second gesture, control the projector to project the image using the first projection method based on the user's gesture being the first gesture, and control the projector to project the image using the second projection method based on the user's gesture being the second gesture, and based on the user's gesture being not detected, control the projector to project the image using the second projection method.

According to an aspect of the disclosure, a method of operating a mobile projector device may include determining whether to set the mobile projector device as an extension display device associated with a source device, receiving information about an image from the source device based on determining to set the mobile projector device as the extension display device, determining a projection position for projecting the image (e.g., a projection position of the mobile projector device for projecting the image) based on position information about the source device, and projecting the image at the projection position (e.g., while the mobile projector device is at the projection position).

The determining whether to set the mobile projector device as the extension display device may include receiving, from the source device, a request message for requesting to set the mobile projector device as the extension display device, determining whether a projection operation is being performed based on reception of the request message, based on determining that the projection operation is being performed, determining to not set the mobile projector device as the extension display device, and transmitting a reject message to the source device, and based on determining that the projection operation is not being performed, determining to set the mobile projector device as the extension display device and transmitting an accept message to the source device.

The method may include controlling a drive assembly of the mobile projector device to move the mobile projector device to the projection position.

The projecting the image may include identifying an area adjacent to the source device, and projecting the image to the identified area.

The method may include identifying a control signal generated based on interaction with a UI of the mobile projector device, and based on the identified control signal, stopping projecting the image and releasing the setting of the mobile projector device as the extension display device, where the identified control signal may include at least one instruction to project a different image or at least one instruction to move the mobile projector device.

The information about the image may include information about at least one of an image received in real-time by the source device, an image associated with an application executed on the source device, an image associated with a camera connected to the source device, and an image provided from a mobile terminal connected to the source device.

The method may include determining, by at least one of a plurality of sensors or at least one camera of the mobile projector device, a presence or an absence of an obstacle in a direction in which the image is projected, and based on determining the presence of the obstacle, changing the direction in which the image is projected by rotating a main body of the mobile projector device by a predetermined angle.

Projecting the image may include determining, by a first sensor among a plurality of sensors of the mobile projector device, a presence or absence of a change in height at the projection position, based on determining the presence of the change in height, determining, by at least one of a second sensor among the plurality of sensors and at least one camera of the mobile projector device, a presence or absence of a fall section at a position adjacent to the mobile projector device, the fall section indicating an area where the mobile projector device will fall, and projecting the image using a first projection method based on determining the absence of the fall section, and based on determining the absence of the change in height, projecting the image using a second projection method, where the first projection method and the second projection method differ in projection distance or projection direction.

The method may include, based on determining the presence of the fall section, performing, by the at least one camera, a face recognition operation, determining whether a user's face is recognized based on the face recognition operation, and based on the user's face not being recognized, projecting the image using the first projection method.

The method may include, based on determining the presence of the fall section, performing, by the at least one camera, a face recognition operation, determining whether a user's face is recognized based on the face recognition operation, based on the user's face being recognized, determining, by the at least one camera and in a direction in which the user's face is recognized, whether the user's gesture is detected, and based on the user's gesture being detected, identifying whether the user's gesture is a first gesture or a second gesture, projecting the image using the first projection method based on the user's gesture being the first gesture, and projecting the image using the second projection method based on the user's gesture being the second gesture, and based on the user's gesture not being detected, projecting the image using the second projection method.

According to an aspect of the disclosure, a mobile projector device may include a drive assembly, a projector, memory storing instructions, and at least one processor, and the instructions, when executed by the at least one processor, may cause the mobile projector device to, set the mobile projector device as an extension display device associated with a source device, receive, from the source device, information about an image, determine a projection position of the mobile projector device based on position information about the source device, control the drive assembly to move the mobile projector device to the projection position, and control the projector to project the image when the mobile projector device is at the projection position.

The instructions, when executed by the at least one processor, may further cause the mobile projector device to, when the mobile projector device is at the projection position, identify an area adjacent to the source device, and control the projector to project the image to the identified area.

The mobile projector device may include a short-throw projection lens and a long-throw projection lens, and the mobile projector device may be configured to project the image by at least one of a first projection method using the short-throw projection lens and a second projection method using the long-throw projection lens.

The mobile projector device may include an inertial sensor, a distance sensor, and the instructions, when executed by the at least one processor, may further cause the mobile projector device to determine, by the inertial sensor, whether the projection position has a change in height.

The instructions, when executed by the at least one processor, may further cause the mobile projector device to, based on determining that the projection position has a change in height, determine, by the distance sensor, whether the change in height will cause the mobile projector device to fall, and based on determining that the change in height will not cause the mobile projector device to fall, control the projector to project the image using the first projection method.

The instructions, when executed by the at least one processor, may further cause the mobile projector device to, based on determining that the projection position has a change in height, determine, by the distance sensor, whether the change in height will cause the mobile projector device to fall, and based on determining that the change in height will cause the mobile projector device to fall, perform a face recognition operation, determine whether a user's face is recognized by the face recognition operation, and based on the user's face not being recognized, control the projector to project the image using the first projection method.

The instructions, when executed by the at least one processor, may further cause the mobile projector device to, based on determining that the projection position has a change in height, determine, by the distance sensor, whether the change in height will cause the mobile projector device to fall, and based on determining that the change in height will cause the mobile projector device to fall, perform a face recognition operation, determine whether a user's face is recognized by the face recognition operation, based on the user's face being recognized, determine, by at least one camera and in a direction in which the user's face is recognized, whether the user's gesture is detected, based on the user's gesture being detected, identify whether the user's gesture is a first gesture or a second gesture, control the projector to project the image using the first projection method based on the user's gesture being the first gesture, and control the projector to project the image using the second projection method based on the user's gesture being the second gesture, and based on the user's gesture being not detected, control the projector to project the image using the second projection method.

The instructions, when executed by the at least one processor, may further cause the mobile projector device to, based on determining that the projection position does not have a change in height, control the projector to project the image using the second projection method.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1A is a diagram illustrating a mobile projector according to one or more embodiments;

FIG. 1B is a block diagram illustrating a configuration of a mobile projector according to one or more embodiments;

FIG. 2 is a diagram illustrating a mobile projector and a source device according to one or more embodiments;

FIG. 3 is a flowchart illustrating operations of a mobile projector according to one or more embodiments;

FIG. 4A is a flowchart illustrating an operation in which a mobile projector accepts an operation request for operating as an extension display device according to one or more embodiments;

FIG. 4B is a flowchart illustrating a mobile projector and a source device for an extension display device operation according to one or more embodiments;

FIG. 4C is a flowchart illustrating a mobile projector and a source device for an extension display device operation according to one or more embodiments;

FIG. 4D is a diagram illustrating a multi-view setting screen that may be displayed on a source device when a mobile projector may operate as an extension display device of the source device according to one or more embodiments;

FIG. 5A is a flowchart illustrating an operation in which a mobile projector rejects an operation request for operation as an extension display device according to one or more embodiments;

FIG. 5B is a diagram illustrating a multi-view setting screen that may be displayed on a source device when a mobile projector may not operate as an extension display device of the source device according to one or more embodiments;

FIG. 6A is a diagram illustrating an example of a multi-view displayed on a source device according to one or more embodiments;

FIG. 6B is a diagram illustrating a multi-view of a source device where a mobile projector icon is displayed, according to one or more embodiments;

FIG. 6C is a diagram illustrating an example of a multi-view based on selection of a mobile projector icon according to one or more embodiments;

FIG. 7A is a flowchart illustrating operations of a source device and a mobile terminal for displaying a multi-view associated with the mobile terminal according to one or more embodiments;

FIG. 7B is a diagram illustrating an example of a multi-view of a source device including an image of a mobile terminal according to one or more embodiments;

FIG. 8A is a flowchart illustrating an operation of a mobile terminal, a source device, or a mobile projector for displaying a multi-view associated with the mobile terminal according to one or more embodiments;

FIG. 8B is a flowchart illustrating another operation of a mobile terminal, a source device, or a mobile projector for displaying a multi-view associated with the mobile terminal according to one or more embodiments;

FIG. 8C is a diagram illustrating an example in which an image of a mobile terminal, constituting a multi-view, is projected in an area adjacent to a source device according to one or more embodiments;

FIG. 8D is a diagram illustrating an example in which an image of a mobile terminal, constituting a multi-view, is projected in an area adjacent to a user according to one or more embodiments;

FIG. 9 is a diagram illustrating examples of projectable areas based on a position of a source device according to one or more embodiments;

FIGS. 10A and 10B are diagrams illustrating examples of sources for a multi-view according to one or more embodiments;

FIG. 11 is a flowchart illustrating an operation in which a mobile projector determines a projection position according to one or more embodiments;

FIG. 12 is a diagram illustrating an example of a map available in a mobile projector according to one or more embodiments;

FIG. 13A is a flowchart illustrating an operation in which a mobile projector determines a projection method based on a change in height and whether there is a fall section according to one or more embodiments;

FIG. 13B is a flowchart illustrating an operation in which a mobile projector determines a projection method based on a result of user face recognition and gesture detection according to one or more embodiments;

FIGS. 14A and 14B are diagrams illustrating an example of a circumstance in which a height of a mobile projector is changed according to one or more embodiments;

FIG. 15A is a diagram illustrating a long-throw projection method according to one or more embodiments;

FIG. 15B is a diagram illustrating a short-throw projection method according to one or more embodiments;

FIG. 16 is a flowchart illustrating an operation in which a mobile projector projects an image considering a direction in which a user's face is recognized according to one or more embodiments;

FIG. 17A is a diagram illustrating an operation in which a mobile projector projects an image from a direction opposite to a user's face according to one or more embodiments;

FIG. 17B is a diagram illustrating an operation in which a mobile projector projects an image from a direction in which a user's face is recognized according to one or more embodiments;

FIG. 18 is a flowchart illustrating an operation in which a mobile projector projects an image based on an obstacle detection result according to one or more embodiments;

FIG. 19A is a diagram illustrating an operation in which a mobile projector changes a projection angle for long-throw projection according to one or more embodiments;

FIG. 19B is a diagram illustrating an operation in which a mobile projector changes a projection angle for short-throw projection according to one or more embodiments;

FIG. 20 is a flowchart illustrating an operation in which a mobile projector performs a projection operation based on a user's face or gaze according to one or more embodiments; and

FIG. 21 is a diagram illustrating an operation in which a mobile projector determines a projection angle according to one or more embodiments.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

One or more embodiments of the disclosure may provide a mobile projector and a method for operating the mobile projector.

One or more embodiments of the disclosure may provide a mobile projector that may be used as an extension monitor (or extension display) and a method for operating the mobile projector.

One or more embodiments of the disclosure may provide a mobile projector that may configure a multi-view with a source device and a method for operating the mobile projector.

One or more embodiments of the disclosure may provide a mobile projector that projects an image considering a user's position or a position of a source device and a method for operating the mobile projector.

One or more embodiments of the disclosure may provide a mobile projector that projects an image to a position corresponding to a user's gaze and a method for operating the mobile projector.

One or more embodiments of the disclosure may provide a mobile projector that determines a projection position or projection method based on a change in the circumstance of the mobile projector, surrounding environment information, or information about a user and a method for operating the mobile projector.

One or more embodiments of the disclosure may provide a mobile projector that determines a projection position or a projection method based on a user's face position or gesture and a method for operating the mobile projector.

One or more embodiments of the disclosure may provide a mobile projector that projects an image while avoiding an obstacle and a method for operating the mobile projector.

One or more embodiments of the disclosure may provide a mobile projector that determines a projection position or projection method to efficiently provide content to a user and a method for operating the mobile projector.

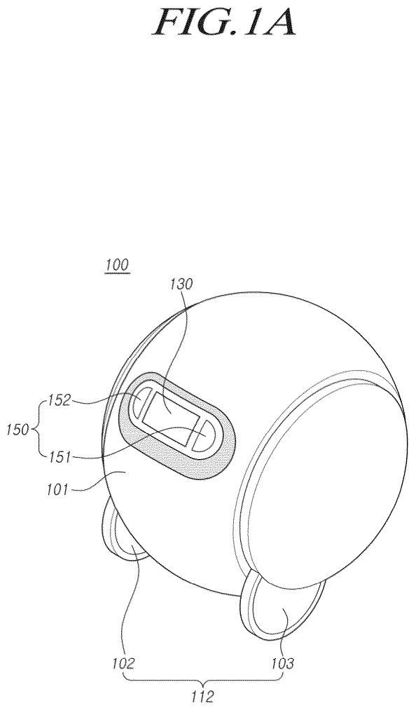

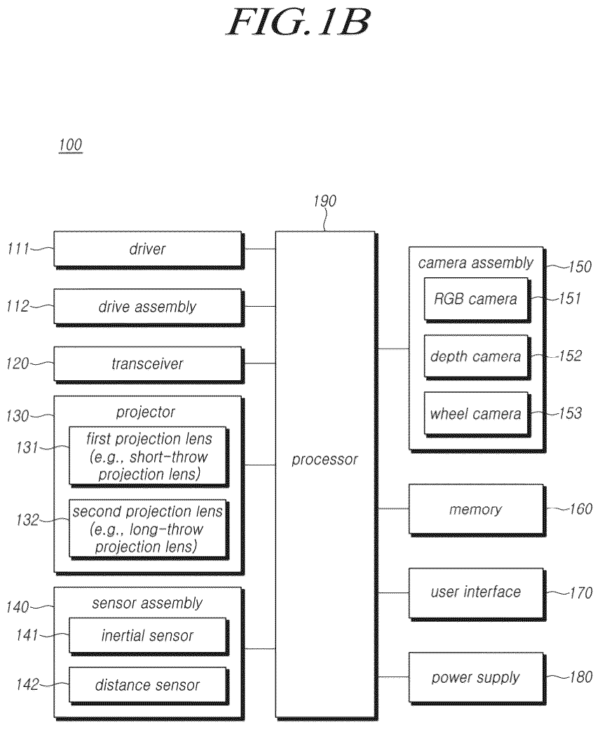

FIG. 1A is a diagram illustrating a mobile projector according to one or more embodiments.

Referring to FIG. 1A, the mobile projector 100 may include a main body 101, a drive assembly 112, a projector 130, and a camera assembly 150. According to one or more embodiments, the mobile projector 100 may correspond to a mobile robot including a projector function.

The main body 101 may form an external appearance of the mobile projector 100. For example, the main body 101 may form a cylindrical or spherical exterior, but is not limited thereto and may form another type of exterior such as a hexahedron. The main body 101 may be configured to be rotatable. For example, the main body 101 may be rotated by a motor and may be rotated based on a preset angle or direction. The motors may be provided on two opposite sides, respectively, of the main body 101.

The drive assembly 112 may include at least one wheel used to move the main body 101 and at least one wheel motor configured to rotate the at least one wheel. For example, the drive assembly 112 may include a first wheel 102 and a second wheel 103 installed at lower portion of two opposite sides of the main body 101, and two wheel motors that rotate the first wheel 102 and the second wheel 103, respectively. The first wheel 102 and the second wheel 103 may have configurations corresponding to each other, and may be installed in a symmetrical form with respect to the main body 101.

The drive assembly 112 may further include at least one auxiliary wheel for assisting the first wheel 102 and the second wheel 103. At least one auxiliary wheel may be installed in the front or rear of the lower side of the main body 101, but is not limited thereto.

The projector 130 may be included in the front surface of the main body 101 and configured to project an image. The projector 130 may be referred to as a projecting module, a projection module, or a projector. The projector 130 may project an image to a first area (e.g., a wall surface or a screen) or a second area (e.g., a floor surface) based on the rotation angle or rotation direction of the main body 101.

The camera assembly 150 may include at least one camera included in the front of the main body 101. For example, at least one camera may include an RGB camera 151 and/or a depth camera 152 disposed at a position adjacent to the projector 130, but is not limited thereto.

Hereinafter, a detailed configuration of the mobile projector 100 illustrated in FIG. 1A is described with reference to FIG. 1B.

FIG. 1B is a block diagram illustrating a configuration of a mobile projector according to one or more embodiments.

Referring to FIG. 1B, the mobile projector 100 may include a driver 111, a drive assembly 112, a transceiver 120, a projector 130, a sensor assembly 140, a camera assembly 150, a memory 160, a user interface (UI) 170, a power supply 180, and a processor 190. According to one or more embodiments, the mobile projector 100 may include an additional component (e.g., a display) in addition to the illustrated components, or may omit at least one of the illustrated components.

The driver 111 may include at least one motor for rotating the main body 101. At least one motor may be driven based on a control signal provided by the processor 190. At least one motor may be driven to control a rotation angle or direction of the main body 101.

The drive assembly 112 may include at least one wheel (e.g., the first wheel 102 and the second wheel 103 of FIG. 1) used for moving or driving the mobile projector 100 and at least one wheel motor. At least one wheel motor may be connected to at least one wheel and may be driven to rotate at least one wheel.

The transceiver 120 may support establishment of a wired communication channel or wireless communication channel between the mobile projector 100 and a source device or an external electronic device (e.g., a home appliance, a mobile terminal, or a server), and performing communication through the established communication channel.

According to one or more embodiments, the transceiver 120 may include a wired communication module and/or a wireless communication module. For example, a wired communication module may include a local area network (LAN) communication module or a power line communication module, and a wireless communication module may include a short-range communication module and/or a mobile communication module.

The short-range communication module may include at least one of a near field communication (NFC) communication module, a radio-frequency identification (RFID) communication module, a Zigbee communication module, a wireless fidelity (Wi-Fi) communication module, a Wi-Fi direct communication module, a Bluetooth communication module, a Bluetooth low energy (BLE) communication module, a wireless local area network (WLAN) communication module, an Ant+ communication module, an ultra-wideband (UWB) communication module, an infrared data association (IrDA) communication module, or a microwave (uWave) communication module.

The mobile communication module may include at least one communication module capable of communicating with an external electronic device through a long-range communication network, such as a legacy cellular network, a 5G network, a next-generation communication network, the Internet, or a computer network (e.g., LAN or wide area network (WAN)).

The transceiver 120 may include an antenna module used to transmit or receive a signal or power to/from the outside (e.g., a source device or an external electronic device) or may be connected to the antenna module. The antenna module may include one or more antennas (e.g., array antennas).

The projector 130 may be configured to project an image. According to one or more embodiments, the image may include at least one of a still image, a video, a real-time streaming image, a broadcast image, a simulation image, an interactive image, or an animation image.

The projector 130 may include at least two projection lenses. For example, at least two projection lenses may include a first projection lens 131 and a second projection lens 132. The first projection lens 131 and the second projection lens 132 may project an image based on different focal lengths or different projection distances. The first projection lens 131 and the second projection lens 132 may project an image based on different projection directions or different projection angles.

According to one or more embodiments, the first projection lens 131 may represent a projection lens having a short focal length (or projection distance) compared to the second projection lens 132. The second projection lens 132 may represent a projection lens having a long focal length (or projection distance) compared to the first projection lens 131. The first projection lens 131 may be referred to as a short-throw projection lens, and the second projection lens 132 may be referred to as a long-throw projection lens.

According to one or more embodiments, the image projected through the first projection lens 131 may be projected into a first area (e.g., a bottom surface) a first distance away from the mobile projector in the first direction. The image projected through the second projection lens 132 may be projected into a second area (e.g., a wall surface) a second distance away from the mobile projector 100 in the second direction. The first distance may be shorter than the second distance, and the first direction and the second direction may be different from each other. The first direction and/or the second direction may be determined based on the rotation angle of the main body 101 of the mobile projector 100.

The first projection lens 131 or the second projection lens 132 may be selectively used for the projection operation. One of the first projection lens 131 and the second projection lens 132 may be selected based on the rotation angle of the main body 101. For example, one of the first projection lens 131 or the second projection lens 132 may be selected for projection operation based on an angle (e.g., 90 degrees) rotated clockwise from the default angle (or initial set angle) (e.g., 0 degrees from the axis parallel to the floor) or an angle (e.g., −90 degrees) rotated counterclockwise from the default angle.

The sensor assembly 140 may include a plurality of sensors configured to detect information about the surrounding environment of the mobile projector 100. For example, the sensor assembly 140 may include an inertial sensor 141 and/or a distance sensor 142.

The inertial sensor 141 may measure the motion state of the mobile projector 100. For example, the inertial sensor 141 may be an inertial measurement unit (IMU) sensor including an accelerometer that measures the acceleration of the mobile projector 100 and a gyroscope that measures the angular velocity of the mobile projector 100.

According to one or more embodiments, when the mobile projector 100 ascends or descends, a change in height (or altitude) of the mobile projector 100 may be detected based on the acceleration measured by the accelerometer in the ascending or descending direction.

According to one or more embodiments, based on the rotation speed of the mobile projector 100 measured by the gyroscope, the direction and speed of the height change of the mobile projector 100 may be estimated.

The measurement results by the accelerometer and the gyroscope may be combined to more accurately detect whether the height of the mobile projector 100 changes.

The distance sensor 142 may be a sensor that measures a distance to an object (e.g., a person, a thing, an animal, a structure, or an obstacle). For example, the distance sensor 142 may include at least one of an ultrasonic sensor that measures the distance to the object by measuring the reflection time using ultrasonic signals, an infrared sensor that measures the distance to the object by detecting the reflection of the infrared signal from the object, and a time-of-flight (ToF) sensor that measures the distance to the object using light or laser pulses.

The sensor assembly 140 may further include a sensor capable of measuring the location and distance to an object, such as a laser imaging detection and ranging (LiDAR) sensor or a radio detection and ranging (RADAR) sensor.

The camera assembly 150 may include at least one camera. At least one camera may capture a still image or a video or function as an image sensor. For example, the camera assembly 150 may be used to detect the surrounding environment of the mobile projector 100, discover the user, identify the user's face, pupil (iris), or gesture, or recognize the object.

According to one or more embodiments, the camera assembly 150 may include an RGB camera 151, a depth camera 152, or a wheel camera 153.

The RGB camera 151 may be used to analyze and compare colors. The RGB camera 151 may include a sensor that recognizes a color of red, green, or blue.

The depth camera 152 may measure a distance between the mobile projector 100 and the object in a three-dimensional (3D) space. The depth camera 152 may measure the distance to the object based on a ToF method, and may be used for motion estimation of the object or recognition of the user's gesture.

The wheel camera 153 may be a camera that may be mounted on at least one wheel included in the drive assembly 112. The wheel camera 153 may be used to estimate the position or direction of the mobile projector 100 by detecting a line or pattern of the ground, or to identify the driving path of the mobile projector 100.

The memory 160 may store various data that may be used to control the operation of each component of the mobile projector 100. The memory 160 may store, e.g., multiple application programs used in the mobile projector 100, data for controlling the operation of the mobile projector 100, and instructions. At least some of the application programs stored in the memory 160 may be downloaded from the outside (e.g., a server) through wireless communication. At least some of the application programs stored in the memory 160 may be stored in the memory 160 from the time of shipment for default functions of the mobile projector 100.

The memory 160 may store at least one program for processing and controlling the processor 190, and may store input and/or output data. The memory 160 may store an artificial intelligence (AI) model. The memory 160 may include at least one of a flash memory type, a hard disk type, a multimedia card micro type, a card type memory (e.g., secure digital (SD) or extreme digital (XD) memory, random access memory (RAM), static random access memory (SRAM), read-only memory (ROM), electrically erasable programmable read-only memory (EEPROM), programmable read-only memory (PROM), a magnetic memory, a magnetic disc, and an optical disc. According to one or more embodiments, a web storage or a cloud server that performs a storage function on the Internet may be operated by the mobile projector 100.

The UI 170 may include various types of input devices for receiving commands or data to be used in the component (e.g., the processor 190) of the mobile projector 100 from the outside (e.g., the user). For example, the UI 170 may include at least one of a microphone, microphone array, keypad, touchpad, trackball, jog switch, or a touch screen that receives a touch input and displays a graphical user interface (GUI).

The UI 170 may include various types of output devices for displaying or outputting various types of information related to the operation of the mobile projector 100. For example, the UI 170 may include a display for visually displaying information, a sound output device for outputting information as a voice or sound signal (e.g., warning sound, notification sound, or music), or a vibration mechanism that generates mechanical vibration for notification or warning.

The power supply 180 may include a device or a circuit that supplies power to the mobile projector 100. The power supply 180 may include an interface capable of receiving power from an external power supply device and a battery for storing power provided from an external power supply device. The power supply 180 may include a rechargeable battery charged with power for operating the mobile projector 100 in place of an interface and a battery.

The processor 190 may control the overall operation of the mobile projector 100 and may perform operations of the mobile projector 100 to be described below. The processor 190 may perform computation or data processing related to control and/or communication of at least one other component of the mobile projector 100. For example, the processor 190 may be electrically connected to the driver 111, the drive assembly 112, the transceiver 120, the projector 130, the sensor assembly 140, the camera assembly 150, the memory 160, the UI 170, and the power supply 180, and may execute the instructions of the program stored in the memory 160. The processor 190 may include a processing circuit that executes instructions of the program stored in the memory 160. The processor 190 may include at least one of a central processing unit (CPU), a neural processing unit (NPU), a graphics processing unit (GPU), a micro processing unit (MPU), a micro controller unit (MCU), an application processor (AP), a communication processor (CP), a system on chip (SoC), or an integrated circuit (IC) sensor hub, a supplementary processor, an application specific integrated circuit (ASIC), or a field programmable gate arrays (FPGA), and may include a plurality of cores.

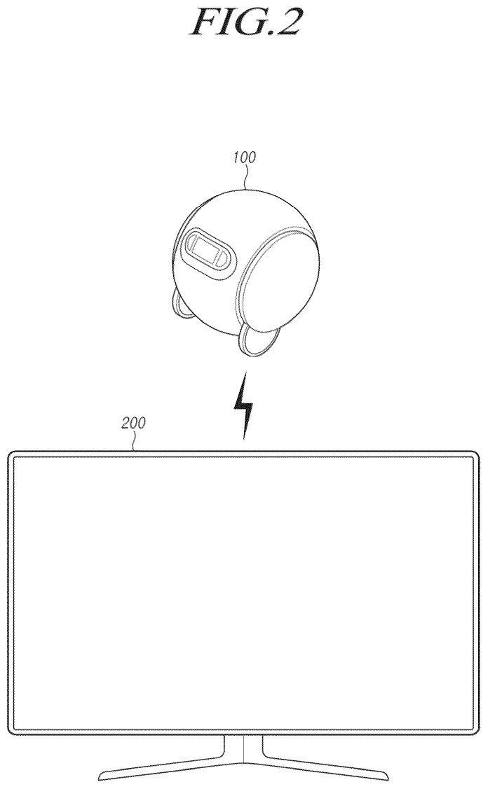

FIG. 2 is a diagram illustrating a mobile projector and a source device according to one or more embodiments.

Referring to FIG. 2, the source device 200 may be an external electronic device capable of providing an image source or image information (e.g., content information and/or video frame). The source device 200 may be any one of, e.g., a mobile terminal such as a smartphone or a tablet personal computer (PC), a wearable device, a laptop computer, a PC, or a home appliance including a display, such as a television (TV).

The mobile projector 100 is a sink device corresponding to the source device 200, and may be set as an extension monitor (or extension display). The setting of the extension display device may be a setting for extending the display area of the source device 200. When the mobile projector 100 is set as an extension display device, the mobile projector 100 may receive an image from the source device 200 and perform a display operation or a projection operation. When the mobile projector 100 is set as an extension display device, the mobile projector 100 may be connected to the source device 200 to provide a wider display space. According to the setting of the extension display device, the display space of the image may be moved away from the display of the source device 200 to another space (e.g., the projection space of the mobile projector 100). For example, the image displayed on the source device 200 may be transferred to the mobile projector 100 and projected, and the image projected by the mobile projector 100 may be displayed again on the source device 200.

The mobile projector 100 and the source device 200 may be wirelessly connected based on wireless communication without the use of a cable (e.g., a high-definition multimedia interface (HDMI) cable), an adapter, or a display port within a local network.

The wireless connection may be performed for wireless display. The wireless display may represent display based on a wireless connection between at least two devices. For example, wireless display may include Wi-Fi display, screen mirroring, or display associated with screen sharing. Wireless display may be performed based on various standards such as Miracast, Wi-Fi direct, Chromecast, Intel Wireless Display (WiDi), or AirPlay.

A wireless connection may be a peer-to-peer (P2P) connection, and may not require an additional infrastructure such as a server, router, or access point.

According to one or more embodiments, the mobile projector 100 may obtain image information from the source device 200 based on being set as an extension display device. For example, the image information may include information about content being displayed or to be displayed on the source device 200, or configuration information about audio and/or video frames, text, or graphics associated with the content. According to one or more embodiments, the mobile projector 100 may perform a projection operation based on image information obtained from the source device 200. For example, the mobile projector 100 may project an image that is the same as or different from the image displayed on the source device 200 based on image information obtained from the source device 200.

According to one or more embodiments, the mobile projector 100 may configure a multi-view with the source device 200 based on being set as an extension display device. The operation of the mobile projector 100 for multi-view may be included in the operation of the extension display device.

The multi-view may include two or more views. The two or more views may include a screen associated with two or more sources (or multi-view sources) (e.g., images). The two or more sources may be related to an image provided from at least one of an application installed on the source device 200, a broadcast channel available in the source device 200, or an external electronic device (e.g., a mobile terminal or a USB camera) connected to the source device 200. The two or more sources may be selected by the user.

If the mobile projector 100 is not set as an extension display device, two or more views may be displayed on the source device 200. For example, if the mobile projector 100 is not set as an extension display device and the multi-view includes a first view and a second view, the first view and the second view may be displayed on the source device 200.

If the mobile projector 100 is set as an extension display device, at least one of the two or more views may be displayed on the source device 200, and another one of at least one of the two or more views may be projected (or displayed) by the mobile projector 100. For example, if the mobile projector 100 is set as an extension display device and the multi-view includes a first view and a second view, the first view may be displayed on the source device 200, and the second view may be projected by the mobile projector 100.

According to one or more embodiments, the first view may include a screen of a broadcast program received by the source device 200, and the second view may include a screen of an application executed on the source device 200. If the mobile projector 100 is set as an extension display device, the user may use an application executed on the source device 200 while watching the broadcast program based on the first view displayed on the source device 200 and the second view projected by the mobile projector 100.

According to one or more embodiments, the first view may include the screen of the broadcast program received by the source device 200, and the second view may include the screen of the application executed on the mobile terminal. If the mobile projector 100 is set as an extension display device, the user may use various functions (e.g., application execution, voice or video call, viewing photographs or videos taken, or searching or translating functions) while watching the broadcast program based on the first view displayed on the source device 200 and the second view projected by the mobile projector 100.

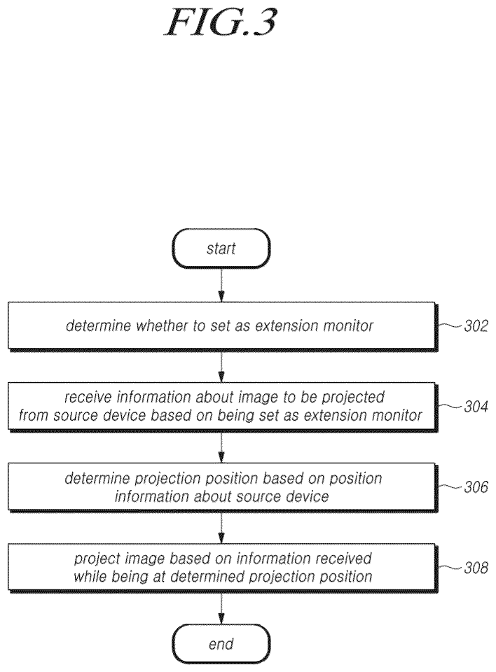

FIG. 3 is a flowchart illustrating operations of a mobile projector according to one or more embodiments.

Referring to FIG. 3, in operation 302, the mobile projector 100 may determine whether to set the mobile projector 100 as an extension display device associated with the source device 200. According to one or more embodiments, the mobile projector 100 may include operation state information indicating the operation state of the mobile projector 100. The operation state information may be updated based on a change in the operation state of the mobile projector 100. The operation state information may include, e.g., any one of information indicating that the mobile projector 100 is driving, information indicating that the mobile projector 100 is in a stopped state (or a driving-stopped state), information indicating that the mobile projector 100 is projecting, or information indicating that the mobile projector 100 is in a stopped state of not projecting.

The mobile projector 100 may receive a request message requesting setting of the extension display device from the source device 200, and determine whether to set the mobile projector 100 as an extension display device of the source device 200 based on the operation state information.

According to one or more embodiments, if the operation state information includes any one of information indicating that the mobile projector 100 is driving, information indicating that the mobile projector 100 is in a stopped state (or a driving-stopped state), or information indicating that the mobile projector 100 is in a stopped state of not projecting, the mobile projector 100 may determine to set it as an extension display device.

According to one or more embodiments, if the operation state information includes information indicating that it is projecting, the mobile projector 100 may determine not to set it as an extension display device.

In operation 304, the mobile projector 100 may receive information about an image to be projected from the source device 200 based on the mobile projector 100 being set as an extension display device of the source device 200. According to one or more embodiments, the information about the image to be projected may include information about at least one of an image received in real time by the source device (e.g., a broadcast image or a real-time streaming image), an image associated with the application executed on the source device 200, an image associated with the camera (e.g., a USB camera) connected to the source device 200, or an image provided from the mobile terminal connected to the source device 200.

In operation 306, the mobile projector 100 may determine the projection position based on the position information about the source device 200. According to one or more embodiments, the projection position may represent a place or position for projecting the image based on the obtained information, a place or position for determining a projection area to project the image, or a position adjacent to the source device 200. For example, the projection position may represent a place or position of the mobile projector 100 for projecting the image based on the obtained information, a place or position of the mobile projector 100 for determining a projection area to project the image, or a position adjacent to the source device 200. According to one or more embodiments, the position information about the source device 200 may be identified from a map (or a map view) stored in the mobile projector 100. If the projection position is determined, the mobile projector 100 may move to the determined projection position.

In operation 308, the mobile projector 100 may project an image based on information received, while being at the determined projection position. According to one or more embodiments, the mobile projector 100 may determine a projection area while at the determined projection position. The mobile projector 100 may identify the source device 200 while at the projection position and scan a space adjacent to the source device 200 using at least one camera. The mobile projector 100 may determine a projection area based on a scan result. For example, the mobile projector 100 may determine an area without the user or obstacles in a space adjacent to the source device 200 as a projection area, and project an image onto the determined projection area. That is, the mobile projector 100 may identify a projection position to which the mobile projector 100 is to move for projecting the image to be projected. The mobile projector 100 may perform various determinations described herein while the mobile projector 100 is at the determined projection position, while the mobile projector 100 is moving to the determined projection position, and prior to moving to the determined projection position, as will be understood by one of ordinary skill in the art from the disclosure herein. Thus, the phrase “at the projection position” may indicate that the operation is performed while the mobile projector 100 is located at or moved to the projection position.

The mobile projector 100 may not know the position information about the source device 200. In this case, the mobile projector 100 may perform the user discovery (or search) operation without performing operations 306 and 308. For example, the mobile projector 100 may perform an operation for discovering the user through driving. User discovery may be performed based on the user account verification, face recognition, iris recognition, or voice recognition technique using a mobile terminal. If the user is discovered, the mobile projector 100 may determine a projection area at the position where the user is discovered and project an image onto the determined projection area. For example, the mobile projector 100 may determine an area where there is no obstacle adjacent to the position where the user is discovered, an area facing the user's face, or an area corresponding to the user's gaze as a projection area, and project an image to the determined projection area.

The operations illustrated in FIG. 3 are not limited to the illustrated order but may be performed in various orders. For example, the operation of receiving information about the image to be projected in operation 304 may be performed in operation 302 or operation 306. According to one or more embodiments, at least some of the operations illustrated in FIG. 3 may be omitted, or more operations may be performed than those illustrated in FIG. 3.

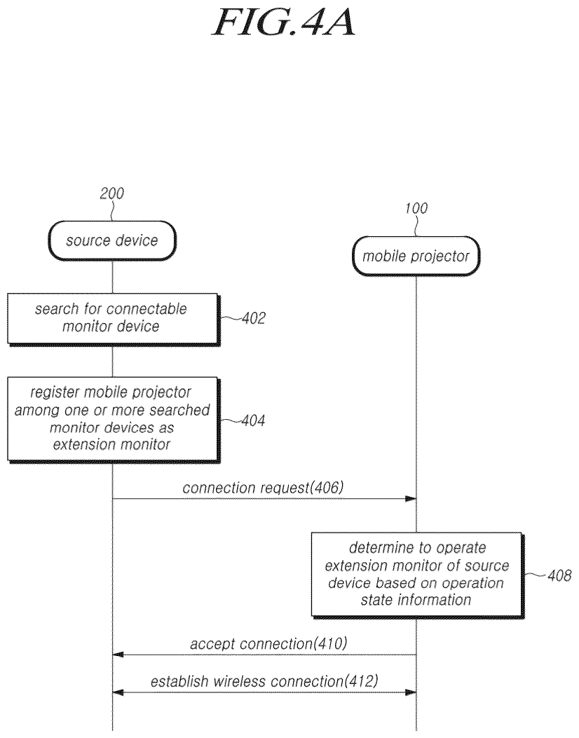

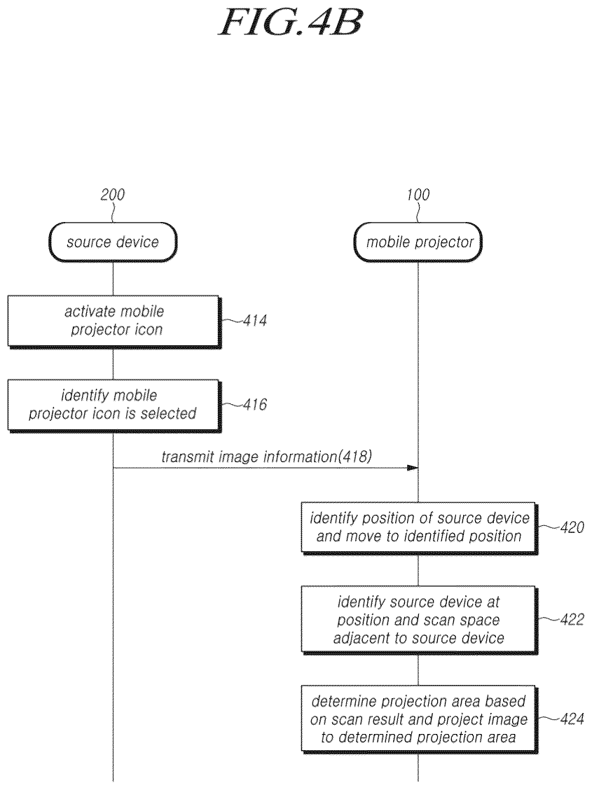

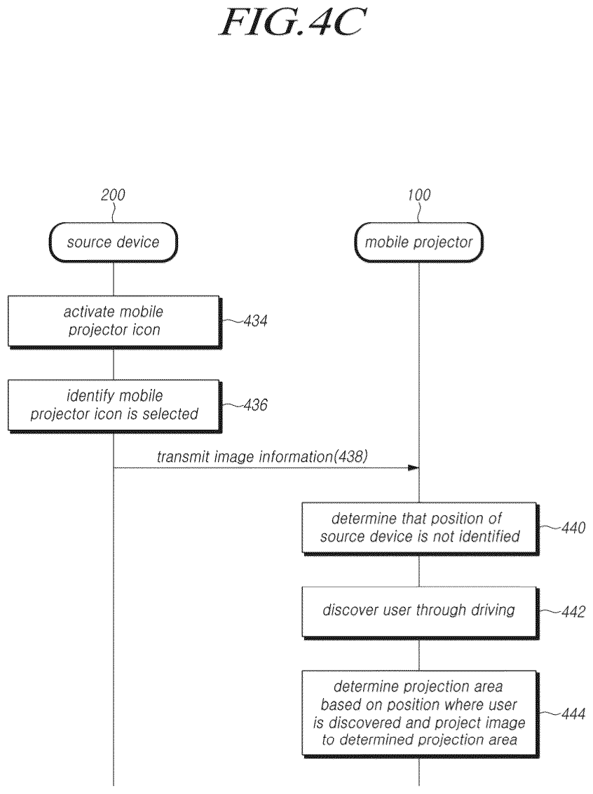

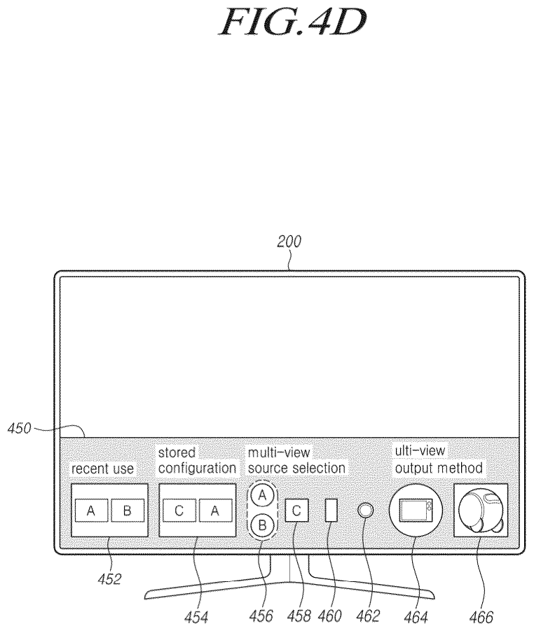

FIG. 4A is a flowchart illustrating an operation in which a mobile projector accepts an operation request for operating as an extension display device according to one or more embodiments.

According to one or more embodiments, the operations illustrated in FIG. 4A may be operations associated with operation 302 of FIG. 3.

Referring to FIG. 4A, in operation 402, the source device 200 may search for a connectable display device. According to one or more embodiments, the source device 200 may search for a display device connectable based on wireless communication (e.g., Wi-Fi or Wi-Fi direct communication). If one or more display devices are searched by the source device 200, the one or more searched display devices may be displayed in the form of icons on the display of the source device 200. For example, names, media access control (MAC) addresses, or identifiers (e.g., serial numbers or product codes) corresponding to the one or more searched display devices may be displayed on the display of the source device 200.

In operation 404, the source device 200 may register the mobile projector 100 among the one or more searched display devices as an extension display device of the source device 200. According to one or more embodiments, if the mobile projector 100 is selected by an external input (e.g., the user's input) among one or more display devices registered in the source device 200, the source device 200 may select the mobile projector 100 as an extension display device of the source device 200. The extension display device may represent a display that displays the image provided from the source device 200 or a projector that projects the image provided from the source device 200.

In operation 406, the source device 200 may transmit a connection request message requesting a wireless connection to the mobile projector 100 based on the mobile projector 100 being selected as an extension display device of the source device 200. According to one or more embodiments, the connection request message may include information indicating that the mobile projector 100 is selected as an extension display device of the source device 200 and/or information requesting the setting of the extension display device (or operation of the extension display device) from the mobile projector 100.

In operation 408, the mobile projector 100 may receive a connection request message and determine to operate as an extension display device of the source device 200 based on the operation state information. For example, the mobile projector 100 may determine to operate as an extension display device of the source device 200 if the operation state information includes any one of information indicating that the mobile projector 100 is driving, information indicating that the mobile projector 100 is in a stopped state (or driving-stopped driving), or information indicating that the mobile projector 100 is in a stopped state of not projecting.

In operation 410, the mobile projector 100 may transmit a connection accept message indicating that the wireless connection is accepted to the source device 200 based on determining to operate as an extension display device of the source device 200.

In operation 412, the mobile projector 100 may establish a wireless connection with the source device 200 based on transmitting the connection accept message to the source device 200.

The source device 200 may receive the connection accept message from the mobile projector 100 and determine that the mobile projector 100 is set (or operated) as an extension display device based on the reception of the connection accept message. Accordingly, the source device 200 may establish a wireless connection with the mobile projector 100 in response to the reception of the connection accept message.

The establishment of a wireless connection may include, e.g., an operation of establishing a channel for wireless communication between the mobile projector 100 and the source device 200, an operation of exchanging device capability information between the mobile projector 100 and the source device 200, or an operation for maintaining a wireless communication session between the mobile projector 100 and the source device 200.

According to one or more embodiments, if a wireless connection between the mobile projector 100 and the source device 200 is established, the operations illustrated in FIG. 4B or 4C may be performed.

FIG. 4B is a flowchart illustrating a mobile projector and a source device for an extension display device operation according to one or more embodiments.

Referring to FIG. 4B, in operation 414, the source device 200 may activate the mobile projector icon based on the completion of the wireless connection establishment between the mobile projector 100 and the source device 200. According to one or more embodiments, the mobile projector icon may be an icon that may be selected to use the mobile projector 100 as an extension display device, and may be displayed on the display of the source device 200.

According to one or more embodiments, the source device 200 may visually and/or functionally activate the mobile projector icon (e.g., saturation increase, brightness enhancement, highlighting, or selectable processing) to activate the mobile projector icon. The visually and/or functionally activated mobile projector icon may indicate a state in which a function related to the mobile projector 100 (e.g., an extension display device function) may be used.

In operation 416, the source device 200 may identify that the activated mobile projector icon is selected.

In operation 418, the source device 200 may transmit image information to the mobile projector 100 based on the selection of the activated mobile projector icon. The image information transmitted to the mobile projector 100 may correspond to an image selected by the user or an image designated by the user to be projected through the mobile projector 100.

The mobile projector 100 may obtain information about the image to be projected by receiving image information from the source device 200.

In operation 420, the mobile projector 100 may identify the position of the source device 200 based on receiving the image information and move to the identified position. For example, the mobile projector 100 may identify the position of the source device 200 based on a pre-stored map or position information about the source device 200.

In operation 422, the mobile projector 100 may identify the source device 200 at the position to which the mobile projector moved and scan a space adjacent to the source device 200. The mobile projector 100 may perform operation 422 while at the identified position, while moving to the identified position, or prior to moving to the identified position. According to one or more embodiments, the mobile projector 100 may scan a space adjacent to the source device 200 using at least one camera included in the camera assembly 150.

In operation 424, the mobile projector 100 may determine a projection area based on the scan result and project an image onto the determined projection area. For example, the mobile projector 100 may determine an obstacle or an area in a space adjacent to the source device 200 as a projection area and project an image onto the determined projection area.

FIG. 4C is a flowchart illustrating a mobile projector and a source device for an extension display device operation according to one or more embodiments.

Operations 434 to 438 of FIG. 4C correspond to operations 414 to 418 of FIG. 4B, and thus detailed descriptions thereof are omitted.

Referring to FIG. 4C, in operation 440, the mobile projector 100 may determine that the position of the source device 200 is not identified. For example, if there is no pre-stored map or position information about the source device 200, the mobile projector 100 may determine that the position of the source device 200 is not identified.

If the position of the source device 200 is not identified, the mobile projector 100 may start driving to discover the user.

In operation 442, the mobile projector 100 may discover the user through driving. For example, the mobile projector 100 may discover the user based on face recognition, iris recognition, or voice recognition techniques.

In operation 444, the mobile projector 100 may determine a projection area based on the position where the user is discovered, and project an image onto the determined projection area. For example, the mobile projector 100 may determine an area where there is no obstacle adjacent to the position where the user is discovered, an area facing the user's face, or an area corresponding to the user's gaze as a projection area, and project an image to the determined projection area. A method for determining the projection area is described below in detail.

FIG. 4D is a diagram illustrating a multi-view setting screen that may be displayed on a source device when a mobile projector may operate as an extension display device of the source device according to one or more embodiments.

According to one or more embodiments, the mobile projector 100 may operate as an extension display device of the source device 200 based on the operations illustrated in FIG. 4A. In this case, the source device 200 may display a multi-view setting screen as illustrated in FIG. 4D on the display.

Referring to FIG. 4D, the multi-view setting screen may be output if a UI (or multi-view UI) for starting or executing the multi-view is selected in the source device 200. The multi-view setting screen may include a multi-view setting UI 450.

The multi-view setting UI 450 may include a GUI such as an icon, button, or window. For example, the multi-view setting UI 450 may include a recently used multi-view icon 452, a stored multi-view icon 454, a plurality of source icons 456, 458, 460 and 462 indicating multi-view sources, or a source device icon 464 and a mobile projector icon 466 for selecting a multi-view output method.

The recently used multi-view icon 452 may indicate configuration information about the recently used multi-view. The recently used multi-view may include the most recently used multi-view, or at least one multi-view used within a predetermined time range (e.g., during the latest week).

The configuration information about the recently used multi-view may include at least one of information about the recently used multi-view sources (e.g., information about applications A and B executed on the source device 200), recently used multi-view layout information (e.g., information about multi-view areas of predetermined sizes arranged left and right), or information about a device (e.g., source device 200) to which each of the recently used multi-view sources is output (displayed or projected).

If the recently used multi-view icon 452 is selected, the source device 200 may provide a multi-view screen based on the configuration information about the recently used multi-view to the user. For example, screens for applications A and B executed on the source device 200 may be displayed in multi-view areas arranged left and right, respectively, of the source device 200.

The stored multi-view icon 454 may indicate stored multi-view configuration information.

The stored multi-view configuration information may include configuration information about at least one multi-view stored in the source device 200. The configuration information about at least one multi-view stored in the source device 200 may be stored by the user.

For example, the configuration information about the stored multi-view may include at least one of information (e.g., information about the broadcast channel used in the source device 200 and information about the application executed on the source device 200) about the multi-view sources stored in the source device 200, multi-view layout information (e.g., information about the area corresponding to the entire screen of the source device 200 and information about the projection area on the right side of the source device 200) stored in the source device 200, or information about the device (e.g., the source device 200 or the mobile projector 100) outputting each of the stored multi-view sources.

If the stored multi-view icon 454 is selected, the source device 200 may provide a multi-view screen based on the stored multi-view configuration information to the user. For example, the screen of the broadcast program C received by the source device 200 through the broadcast channel may be displayed in the area corresponding to the entire screen of the source device 200, and the screen of the application A may be projected by the mobile projector 100 to the projection area on the right side of the source device 200.

According to one or more embodiments, at least two of the plurality of source icons 456, 458, 460 and 462, the source device icon 464, or the mobile projector icon 466 may be selected by the user without selecting the recently used multi-view icon 452 or the stored multi-view icon 454.

The plurality of source icons 456, 458, 460 and 462 may indicate various types of sources that may be used as multi-view sources.

For example, the plurality of source icons 456, 458, 460 and 462 may include at least one application icon (e.g., icons of application A and/or B) 456 executed on the source device 200, a broadcast channel icon 458 indicating a broadcast channel that may be received or used on the source device 200, a mobile terminal icon 460 indicating a mobile terminal connected to the source device 200, or a camera icon 462 indicating a camera connected to the source device 200. According to one or more embodiments, if there is no mobile terminal or camera connected to the source device 200, the mobile terminal icon 460 or the camera icon 462 may be deactivated or not displayed.

The source device icon 464 and the mobile projector icon 466 may be used to select a multi-view output method. The source device icon 464 may be selected to display the multi-view based on the source device 200, and the mobile projector icon 466 may be selected to display the multi-view based on the source device 200 and the mobile projector 100.

According to one or more embodiments, the mobile projector icon 466 may be selectively displayed. For example, the mobile projector icon 466 may be displayed if the mobile projector 100 is registered as an extension display device of the source device 200, or if the mobile projector 100 is in an operation state in which it may be used as an extension display device. The operation state in which the mobile projector 100 may be used as an extension display device may include a state in which the mobile projector 100 registered as an extension display device is not performing a projection operation, a driving state, or a stopped state in which the projection operation is not performed.

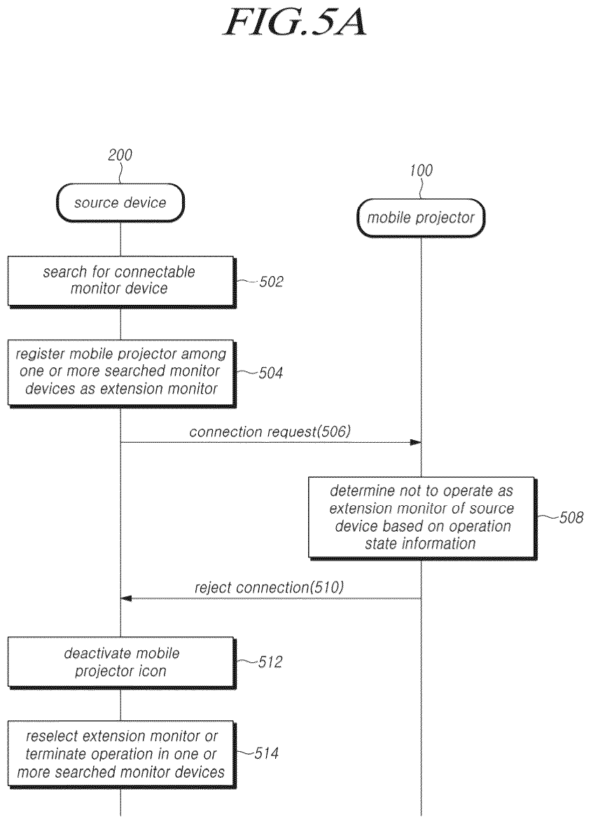

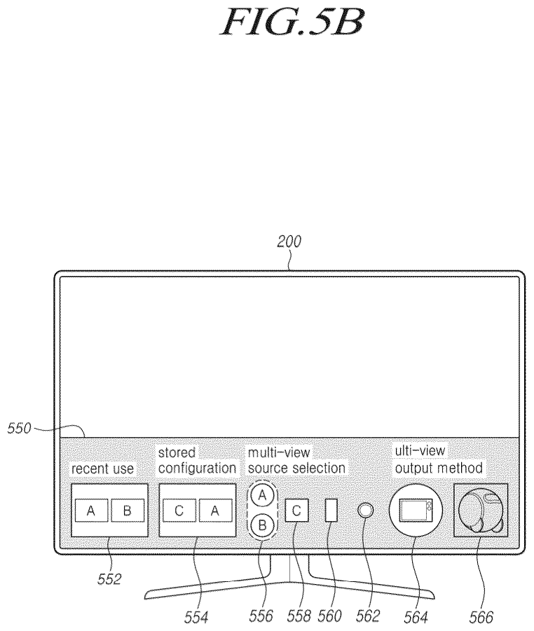

FIG. 5A is a flowchart illustrating an operation in which a mobile projector rejects an operation request for operation as an extension display device according to one or more embodiments.

Referring to FIG. 5A, in operation 502, the source device 200 may search for a connectable device. According to one or more embodiments, the source device 200 may search for a connectable display device based on wireless communication (e.g., Wi-Fi or Wi-Fi direct communication). If one or more display devices are searched by the source device 200, the one or more searched display devices may be displayed in the form of icons on the display of the source device 200. A name, MAC address, or identifier (e.g., serial number or product code) corresponding to one or more searched display devices may be displayed on the display of the source device 200.

In operation 504, the source device 200 may register the mobile projector 100 among the one or more searched display devices as an extension display device of the source device 200. According to one or more embodiments, if the mobile projector 100 is selected by an external input (e.g., the user's input) among one or more searched display devices registered in the source device 200, the source device 200 may select the mobile projector 100 as an extension display device of the source device 200.

In operation 506, the source device 200 may transmit a connection request message requesting a wireless connection to the mobile projector 100 based on the mobile projector 100 being selected as an extension display device. According to one or more embodiments, the connection request message may include information indicating that the mobile projector 100 is selected as an extension display device of the source device 200 and/or information requesting the setting of the extension display device (or operation) from the mobile projector 100.

In operation 508, in response to the connection request message, the mobile projector 100 may receive a connection request message and determine not to operate as an extension display device of the source device 200 based on the operation state information. For example, if the operation state information includes information indicating that the mobile projector 100 is projecting, the mobile projector 100 may determine not to operate as an extension display device of the source device 200.

In operation 510, the mobile projector 100 may transmit a connection reject message indicating that the wireless connection is rejected to the source device 200 based on determining not to operate as an extension display device of the source device 200. According to one or more embodiments, the connection reject message may include information indicating that the mobile projector 100 is not set as an extension display device or the operation of the extension display device is not to be performed and/or information indicating that the mobile projector 100 rejects the setting request (or operation request) of the extension display device.

The source device 200 may determine that the mobile projector 100 is not to be set (or operated) as an extension display device based on receiving the connection reject message from the mobile projector 100.

In operation 512, the source device 200 may deactivate the mobile projector icon in response to the reception of the connection reject message. For example, the source device 200 may indicate that the mobile projector 100 may not be used or selected as an extension display device by visually and/or functionally deactivating the mobile projector icon (e.g., saturation decrease, brightness decrease, dehighlighting, or unselectable processing).

In operation 514, the source device 220 may reselect the extension display device from one or more searched display device devices or terminate the operation.

FIG. 5B is a diagram illustrating a multi-view setting screen that may be displayed on a source device when a mobile projector may not operate as an extension display device of the source device according to one or more embodiments.

According to one or more embodiments, the mobile projector 100 may not operate as an extension display device of the source device 200 based on operations 502 to 510 of FIG. 5A. In this case, the source device 200 may display a multi-view setting screen as illustrated in FIG. 5B on the display.

Referring to FIG. 5B, the multi-view setting screen may include a multi-view setting UI 550. The multi-view setting UI 550 may include the deactivated mobile projector icon 566. The deactivated mobile projector icon 566 may indicate that the mobile projector 100 may not be used or selected as an extension display device. The deactivated mobile projector icon 566 may be a visually and/or functionally deactivated (e.g., saturation decrease, brightness decrease, dehighlighting, or unselectable processing) icon.

The recently used multi-view icon 552, the stored multi-view icon 554, the plurality of source icons 556, 558, 560 and 562, or the source device icon 564 included in the multi-view setting UI 550 respectively correspond to the recently used multi-view icon 452, the stored multi-view icon 454, the plurality of source icons 456, 458, 460 and 462 indicating multi-view sources, or the source device icon 464 for selecting the multi-view output method included in the multi-view setting UI 450 of FIG. 4D, and thus the detailed description thereof is omitted.

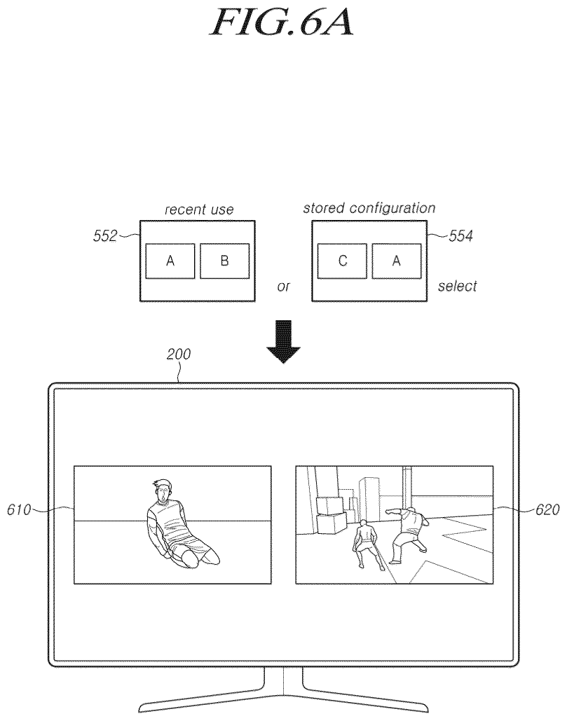

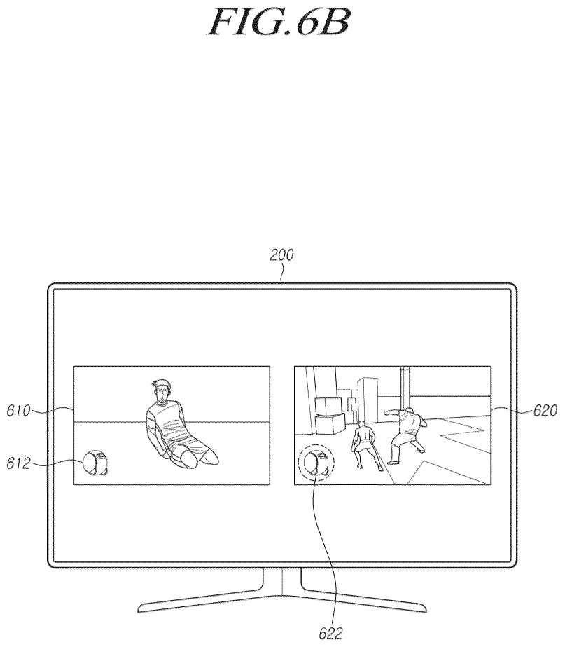

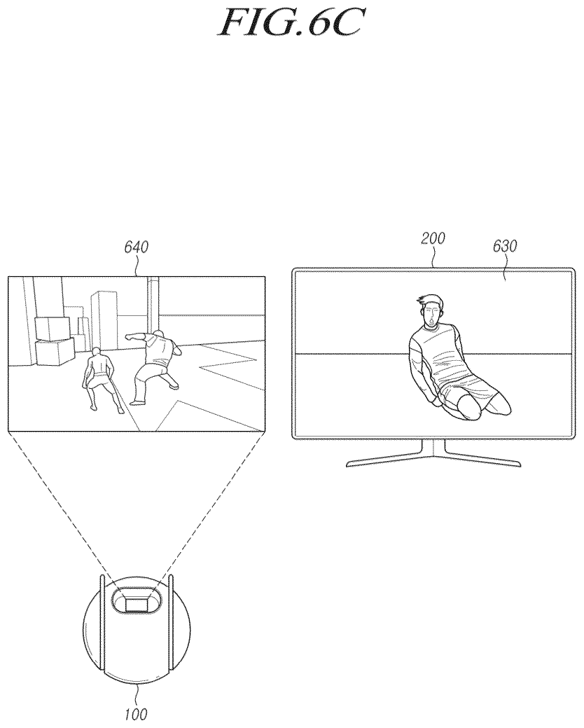

FIG. 6A is a diagram illustrating an example of a multi-view displayed on a source device according to one or more embodiments.

Referring to FIG. 6A, the recently used multi-view icon 552 or the stored multi-view icon 554 may be selected from the multi-view setting UI 550 illustrated in FIG. 5D. If the recently used multi-view icon 552 or the stored multi-view icon 554 is selected, multi-view configuration information (e.g., multi-view sources, multi-view layout, or output device for each multi-view source) is predetermined, so that it is possible to provide multi-view more quickly.

For example, based on the predetermined multi-view configuration information, the source device 200 may identify that it is indicated that the multi-view sources include the broadcast program received through the broadcast channel by the source device 200 and the application executed on the source device 200, and the multi-view layout has two areas of the same size arranged left and right, and the output device of the multi-view sources is the source device 200. The source device 200 may output a screen as illustrated in FIG. 6A, based on the identification result.

According to one or more embodiments, a broadcast program screen (e.g., a soccer game) may be displayed in the first area 610 of the display of the source device 200, and a screen of an application (e.g., a game application) executed on the source device 200 may be displayed in the second area 620 of the display of the source device 200. Based on this, the user may play game while watching the soccer game through the source device 200.

FIG. 6B is a diagram illustrating a multi-view of a source device where a mobile projector icon is displayed, according to one or more embodiments.

According to one or more embodiments, the mobile projector 100 may be set as an extension display device of the source device 200 before or while the screen shown in FIG. 6A is displayed on the source device 200. In this case, the source device 200 may display a mobile projector icon to indicate that the mobile projector 100 is available as an extension display device.

According to one or more embodiments, the source device 200 may display a first mobile projector icon 612 and a second mobile projector icon 622 in the first area 610 and the second area 620, respectively, of the display while displaying a multi-view based on predetermined multi-view configuration information. The first mobile projector icon 612 and the second mobile projector icon 622 may be displayed at predetermined positions (e.g., the lower left of the corresponding area). The first mobile projector icon 612 and the second mobile projector icon 622 may be visually highlighted and displayed.

The first mobile projector icon 612 or the second mobile projector icon 622 may be selected to switch the image output device to the mobile projector 100. If the first mobile projector icon 612 or the second mobile projector icon 622 is selected, the image displayed in the area including the selected icon may be transmitted to the mobile projector 100. For example, if the second mobile projector icon 622 is selected, image information about the game application displayed in the second area 620 may be transmitted to the mobile projector 100. The mobile projector 100 may receive image information from the source device 200 and project the game application based on the received image information.

FIG. 6C is a diagram illustrating an example of a multi-view based on selection of a mobile projector icon according to one or more embodiments.

Based on the selection of the second mobile projector icon 622 in FIG. 6B, a multi-view based on the source device 200 and the mobile projector 100 may be provided.

Referring to FIG. 6C, the source device 200 may transmit image information (e.g., image information about the game application displayed in the second area 620 of FIG. 6B) to the mobile projector 100 based on the selection of the second mobile projector icon 622.

The source device 200 may reconfigure the screen based on the transmission of the image information. For example, the source device 200 may release the first area 610 and the second area 620 (i.e., initiate a process of changing the manner in which the first area 610 and the second area 620 are to be provided), and generate a third area 630 having a predetermined size (e.g., the size corresponding to the entire screen of the display) as an area for multi-view. The source device 200 may display a broadcast program screen displayed in the first area 610 in the third area 630.

The mobile projector 100 may receive image information about the game application executed on the source device 200. The mobile projector 100 may perform a projection operation based on the received image information. For example, the mobile projector 100 may identify the position of the source device 200 and move to the identified position. The mobile projector 100 may identify the source device 200 at the position to which the mobile projector 100 moved and project an image onto an area 640 adjacent to the source device 200 (e.g., a left area of the source device 200 in which an obstacle or the user is not present). If the position of the source device 200 is not identified, the mobile projector 100 may project an image to a position adjacent to the user based on the user search operation through driving.

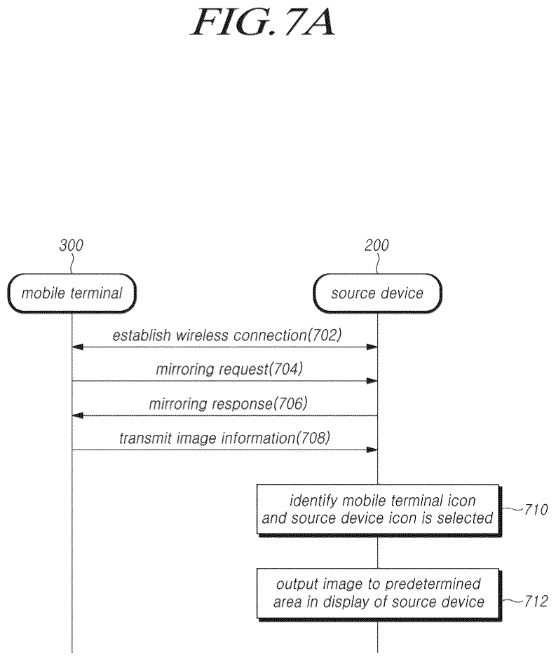

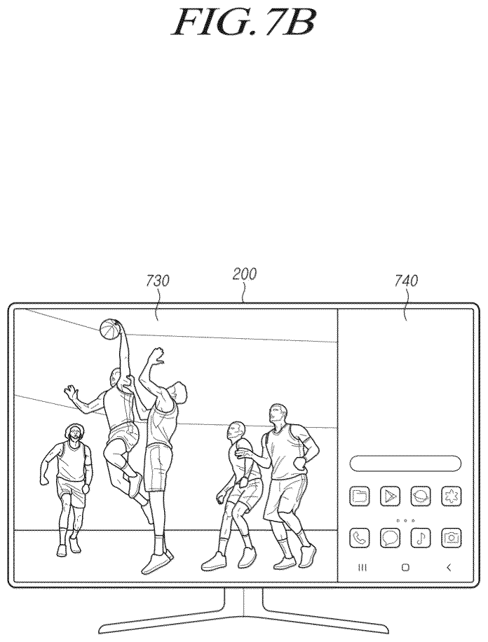

According to one or more embodiments, the source device 200 may use an image of the mobile terminal as a multi-view source. Operations of the source device 200 and the mobile terminal related thereto are described with reference to FIG. 7A.

FIG. 7A is a flowchart illustrating operations of a source device and a mobile terminal for displaying a multi-view associated with the mobile terminal according to one or more embodiments.

Referring to FIG. 7A, in operation 702, the source device 200 may establish a wireless connection with the mobile terminal 300. According to one or more embodiments, the source device 200 may establish a wireless connection with the mobile terminal 300 based on a request of the mobile terminal 300. For example, the source device 200 may establish a wireless connection based on Wi-Fi communication with the mobile terminal 300.

In operation 704, the source device 200 may receive a mirroring request message for screen mirroring from the mobile terminal 300.

In operation 706, the source device 200 may transmit, to the mobile terminal 300, a mirroring response message accepting to mirror the screen of the mobile terminal 300 in response to the mirroring request message. According to one or more embodiments, the source device 200 may transmit a mirroring response message to the mobile terminal 300 based on the user's selection.

In operation 708, the source device 200 may receive image information from the mobile terminal 300 in response to transmitting the mirroring response message. According to one or more embodiments, the source device 200 may receive image information from the mobile terminal 300 in real-time while the wireless connection is maintained. The image information may include information about the screen displayed on the mobile terminal 300. The image information may be stored in a buffer (e.g., a graphic buffer) of the source device 200.

In operation 710, the source device 200 may identify that a mobile terminal icon (e.g., the mobile terminal icon 460 of FIG. 4D or the mobile terminal icon 560 of FIG. 5B) is selected for multi-view source selection, and a source device icon (e.g., the source device icon 464 of FIG. 4D or the source device icon 564 of FIG. 5B) is selected to indicate a multi-view output method.

In operation 712, the source device 200 may output an image to a predetermined area in the display of the source device 200 based on the selection of the mobile terminal icon and the source device icon. For example, the source device 200 may output a screen as illustrated in FIG. 7B on the display.

FIG. 7B is a diagram illustrating an example of a multi-view of a source device including an image of a mobile terminal according to one or more embodiments.

Referring to FIG. 7B, the source device 200 may display a multi-view on the display of the source device 200 based on the selection of the source device icon. The multi-view may be displayed based on a plurality of areas (e.g., the first area 730 and the second area 740) within the display of the source device 200.

For example, if multi-view sources include streaming image received in real-time from the source device 200 and the image of the mobile terminal (e.g., the mobile terminal 300 of FIG. 7A), the source device 200 may display the streaming image in the first area 730 and the image of the mobile terminal in the second area 740. The area in which each image is displayed may be predetermined or designated by the user. The area in which each image is displayed may be changed according to the user's selection after multi-view display.

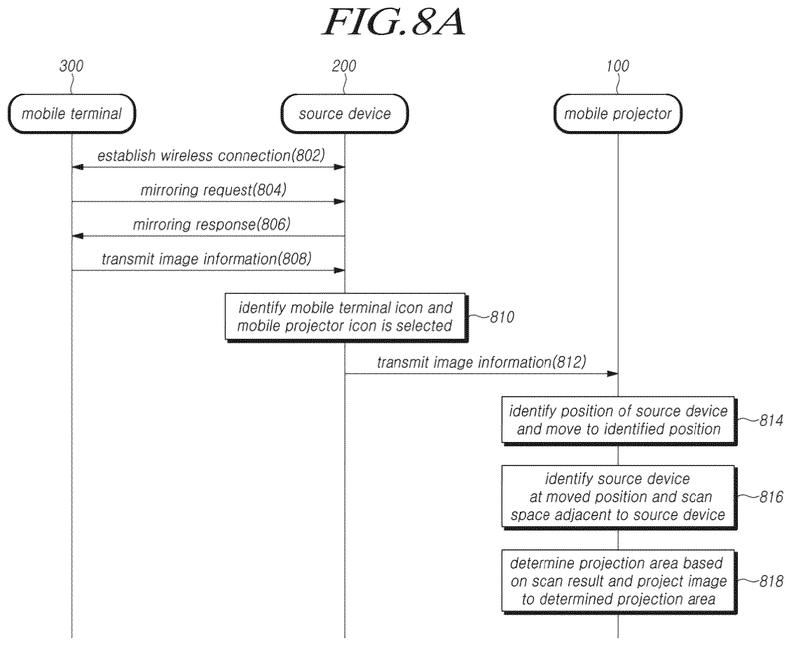

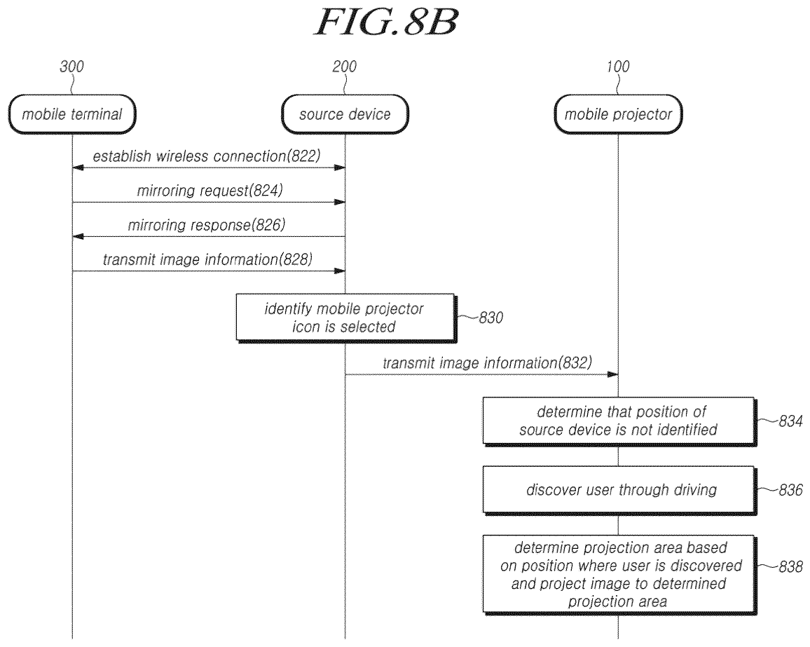

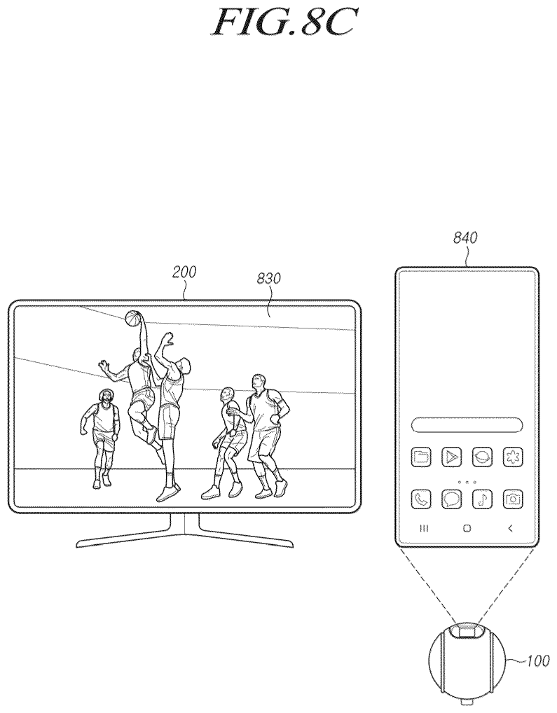

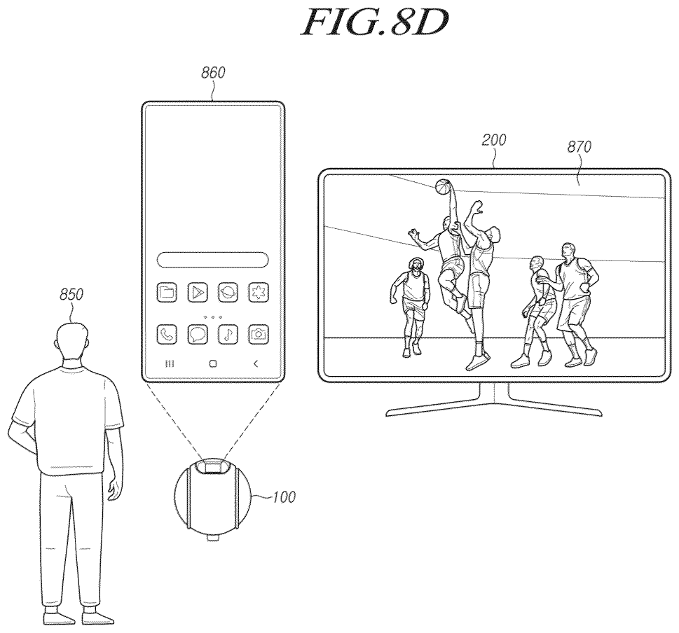

FIG. 8A is a flowchart illustrating an operation of a mobile terminal, a source device, or a mobile projector for displaying a multi-view associated with the mobile terminal according to one or more embodiments.

Operations 802 to 808 of FIG. 8A correspond to operations 702 to 708 of FIG. 7A, and thus a detailed description thereof are omitted.

Referring to FIG. 8A, in operation 810, the source device 200 may identify that a mobile terminal icon (e.g., mobile terminal icon 460 of FIG. 4D) is selected for multi-view source selection and a mobile projector icon (e.g., mobile projector icon 466 of FIG. 4D) is selected to indicate a multi-view output method.

In operation 812, the source device 200 may transmit image information received from the mobile terminal 300 to the mobile projector 100 based on the selection of the mobile terminal icon and the mobile projector icon.

In operation 814, the mobile projector 100 may identify the position of the source device and move to the identified position. For example, the mobile projector 100 may identify the position of the source device 200 based on a pre-stored map or position information about the source device 200.

In operation 816, the mobile projector 100 may identify the source device at the position to which the mobile projector 100 moved and scan a space adjacent to the source device. According to one or more embodiments, the mobile projector 100 may scan a space adjacent to the source device 200 using at least one camera included in the camera assembly 150.

In operation 818, the mobile projector 100 may determine a projection area based on the scan result and project an image (the image of the mobile terminal 300 based on the received image information) onto the determined projection area. For example, the mobile projector 100 may determine an obstacle or an area in a space adjacent to the source device 200 as a projection area and project an image onto the determined projection area.

FIG. 8B is a flowchart illustrating another operation of a mobile terminal, a source device, or a mobile projector for displaying a multi-view associated with the mobile terminal according to one or more embodiments.

Operations 822 to 830 of FIG. 8B correspond to operations 802 to 810 of FIG. 8A, and thus a detailed description thereof are omitted.

Referring to FIG. 8B, in operation 834, the mobile projector 100 may determine that the position of the source device 200 is not identified. For example, if there is no pre-stored map or position information about the source device 200, the mobile projector 100 may determine that the position of the source device 200 is not identified because the position of the source device 200 may not be identified.

If the position of the source device 200 is not identified, the mobile projector 100 may start driving to discover the user.

In operation 836, the mobile projector 100 may discover the user through driving. For example, the mobile projector 100 may discover the user based on face recognition, iris recognition, or voice recognition techniques.

In operation 838, the mobile projector 100 may determine a projection area based on the position where the user is discovered and project an image (the image of the mobile terminal 300 based on the received image information) onto the determined projection area. For example, the mobile projector 100 may determine an area where there is no obstacle adjacent to the position where the user is discovered, an area facing the user's face, or an area corresponding to the user's gaze as a projection area, and project an image to the determined projection area.

FIG. 8C is a diagram illustrating an example in which an image of a mobile terminal, constituting a multi-view, is projected in an area adjacent to a source device according to one or more embodiments.

Referring to FIG. 8C, based on the operations illustrated in FIG. 8A, the mobile projector 100 may project an image of the mobile terminal (e.g., the mirrored screen of the mobile terminal) to an area 840 adjacent to the source device 200. The image of the mobile terminal may configure a multi-view together with the image (e.g., the real-time streamed image of the source device 200) displayed in the display area 830 of the source device 200.

FIG. 8D is a diagram illustrating an example in which an image of a mobile terminal, constituting a multi-view, is projected in an area adjacent to a user according to one or more embodiments.

Referring to FIG. 8D, based on the operations illustrated in FIG. 8B, the mobile projector 100 may project an image of the mobile terminal (e.g., the mirrored screen of the mobile terminal) to an area 860 adjacent to the user 850. Since the mobile projector 100 does not know the position of the source device 200, it may perform an operation of searching for the user 850. The mobile projector 100 may determine that the user 850 is positioned adjacent to the source device 200 and perform the user search operation. If the user 850 is searched, the mobile projector 100 may project the image of the mobile terminal to the position adjacent to the user 850 (e.g., an area in which an obstacle adjacent to the user 850 is not present, an area in a direction facing the user's face, or an area corresponding to the user's gaze). The image of the mobile terminal may configure a multi-view together with the image (e.g., the real-time streamed image of the source device 200) displayed in the display area 870 of the source device 200.

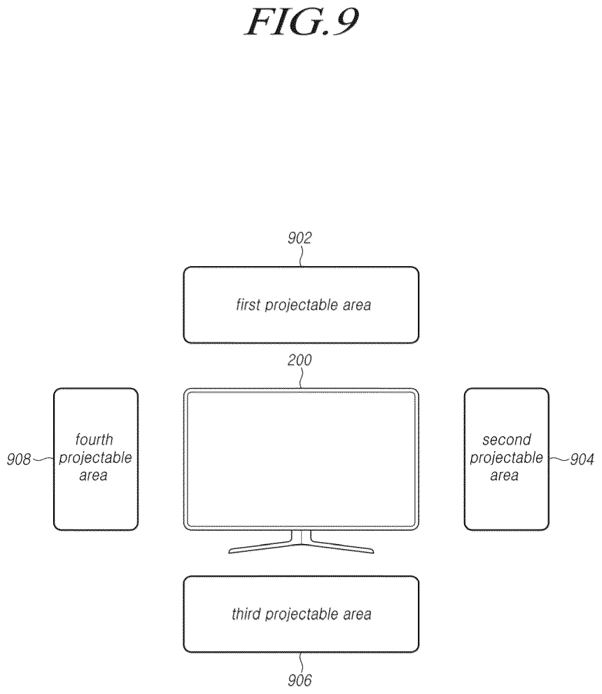

FIG. 9 is a diagram illustrating examples of projectable areas based on a position of a source device according to one or more embodiments.

Referring to FIG. 9, the mobile projector 100 may perform a projection operation for multi-view at various positions. According to one or more embodiments, if the position of the source device 200 is identified based on the stored map (or if the position of the source device 200 is known), the mobile projector 100 may move to the position of the source device 200 (i.e., the mobile projector 100 may move to a position in proximity to the source device 200). The mobile projector 100 may determine a projection position (or a projection area) at the position to which the mobile projector 100 moved. The mobile projector 100 may identify the source device 200 at the position to which the mobile projector 100 moved, and use at least one area adjacent to the source device 200 as a projectable area for multi-view.

According to one or more embodiments, the mobile projector 100 may scan a peripheral space of the source device 200 at the position to which the mobile projector 100 moved, and determine an area in which an obstacle or the user is not present among the areas in the scanned space as a projection area. For example, the mobile projector 100 may use any one of a first projectable area 902 positioned above the source device 200, a second projectable area 904 positioned on the right side of the source device 200, a third projectable area 906 positioned below the source device 200, or a fourth projectable area 908 positioned on the left side of the source device 200 as a projectable area for multi-view. However, this is merely an example, and the projectable area may be variously changed, such as the diagonal position of the source device 200.

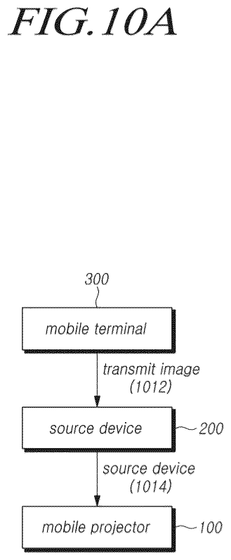

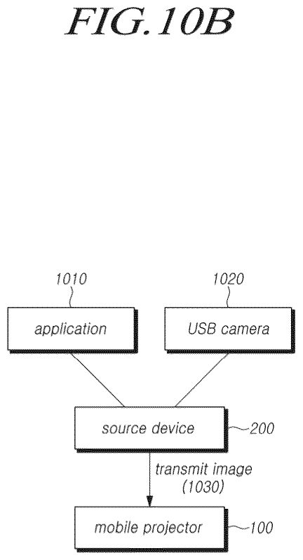

FIGS. 10A and 10B are diagrams illustrating examples of sources for a multi-view according to one or more embodiments.

Referring to FIGS. 10A and 10B, various sources may be used for multi-view.

Referring to FIG. 10A, the multi-view source may include an image provided from the mobile terminal 300. The mobile terminal 300 may be wirelessly connected to the source device 200 and may transmit an image to the source device 200 through the wireless connection (operation 1012).

The source device 200 may transfer the image received from the mobile terminal 300 to the mobile projector 100 so that the image provided from the mobile terminal 300 may be projected through the mobile projector 100 (operation 1014). As such, the image of the mobile terminal 300 may be transferred to the mobile projector 100 through the source device 200.

Referring to FIG. 10B, the multi-view source may include an image associated with an application 1010 installed (or executed) on the source device 200 or a USB camera 1020 connected to the source device 200 through USB.

The source device 200 may transmit the image associated with the application 1010 or the USB camera 1020 to the mobile projector 100 so that the image associated with the application 1010 or the USB camera 1020 may be projected through the mobile projector 100 (operation 1030). As such, the source device 200 may transmit an image related to a device built into the source device 200 or directly (or wiredly) connected to the mobile projector 100.

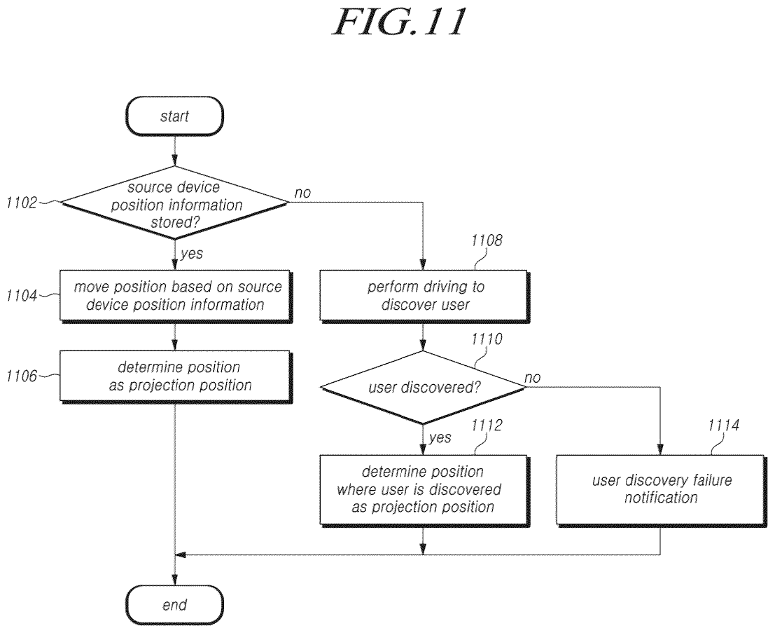

FIG. 11 is a flowchart illustrating an operation in which a mobile projector determines a projection position according to one or more embodiments.

According to one or more embodiments, the operations illustrated in FIG. 11 may be operations associated with operation 306 of FIG. 3.

Referring to FIG. 11, in operation 1102, the mobile projector 100 may determine whether position information about the source device 200 is stored. According to one or more embodiments, the position information about the source device 200 may be identified from a map (or map view) for an indoor space. The map may include a structure for the indoor space (e.g., an arrangement or number of rooms, living rooms, kitchens, bathrooms, windows, veranda, utility rooms, entrances, and exits), or arrangement information or position information for each device. The map may be a two-dimensional (2D) or three-dimensional (3D) map. The map may be generated by the mobile projector 100 based on a simultaneous localization and mapping (SLAM) technology or may be provided from the outside (e.g., a server or an external electronic device).

If the map is stored, the mobile projector 100 may identify position information (e.g., indoor coordinate information) about the source device 200 from the stored map. Based on this, if the map is stored, the mobile projector 100 may determine that position information about the source device 200 is stored.

If it is determined that the position information about the source device 200 is stored, the mobile projector 100 may move based on the position information about the source device 200 in operation 1104. For example, the mobile projector 100 may move to a position corresponding to the position information about the source device 200.

In operation 1106, the mobile projector 100 may determine the identified position to which the mobile projector 100 moved as a projection position (or a position to determine a projection area).

If it is determined that the position information about the source device 200 is not stored, the mobile projector 100 may perform driving for discovering the user in operation 1108.

In operation 1110, the mobile projector 100 may determine whether the user is discovered while driving. According to one or more embodiments, the mobile projector 100 may determine whether the user is discovered based on the user account verification, face recognition, iris recognition, or voice recognition technique using the mobile terminal.

In operation 1112, the mobile projector 100 may determine the position where the user is discovered as the projection position based on discovering the user while driving.

In operation 1114, the mobile projector 100 may output a user discovery failure notification based on not discovering the user while driving. According to one or more embodiments, the mobile projector 100 may visually display the user discovery failure notification through a projection operation using the first projection lens 131 or the second projection lens 132, output it as a voice or sound signal, or generate vibration and output it.

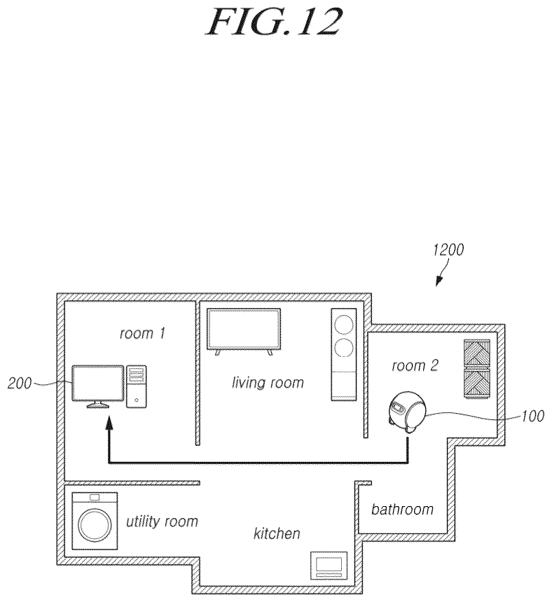

FIG. 12 is a diagram illustrating an example of a map available in a mobile projector according to one or more embodiments.

Referring to FIG. 12, the map 1200 that may be used in the mobile projector 100 may include a virtual map indicating a structure of an indoor space and an arrangement of devices in the indoor space. For example, in the map 1200, the position information about the source device 200 may be indicated by a first icon (or a first indicator) corresponding to the coordinate information about the source device 200, and the position information about the mobile projector 100 may be indicated by a second icon (or a second indicator) corresponding to the coordinate information about the mobile projector 100.

According to one or more embodiments, the mobile projector 100 may receive the map 1200 from a server or load the map 1200 previously generated and stored by the mobile projector 100 based on being registered or selected as an extension display device of the source device 200.

If the map 1200 is obtained, the mobile projector 100 may identify position information about the source device 200 based on the obtained map 1200. The mobile projector 100 may identify the position information about the mobile projector 100 based on the obtained map 1200.

The mobile projector 100 may move the position from the current position (e.g., room 2) of the mobile projector 100 to the position (e.g., room 1) where the source device 200 is present based on the identified position information. According to one or more embodiments, the mobile projector 100 may determine that the user is to be present at a position adjacent to the source device 200, and may perform the user discovery operation after moving the position.

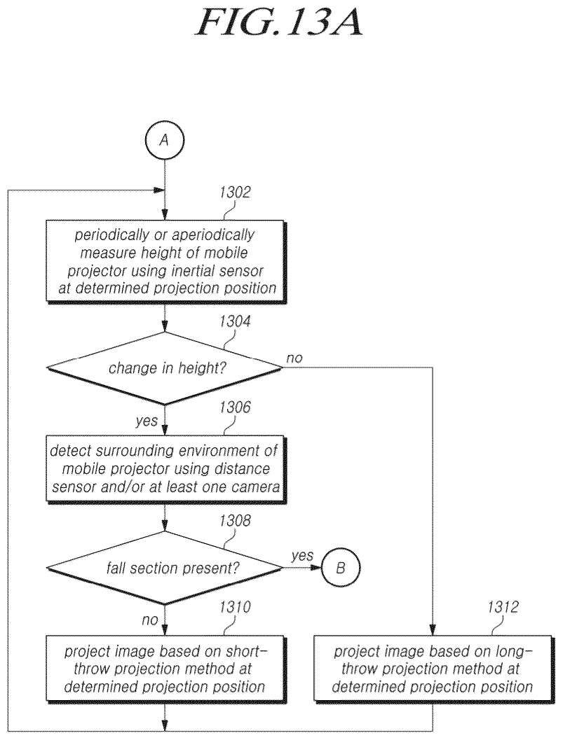

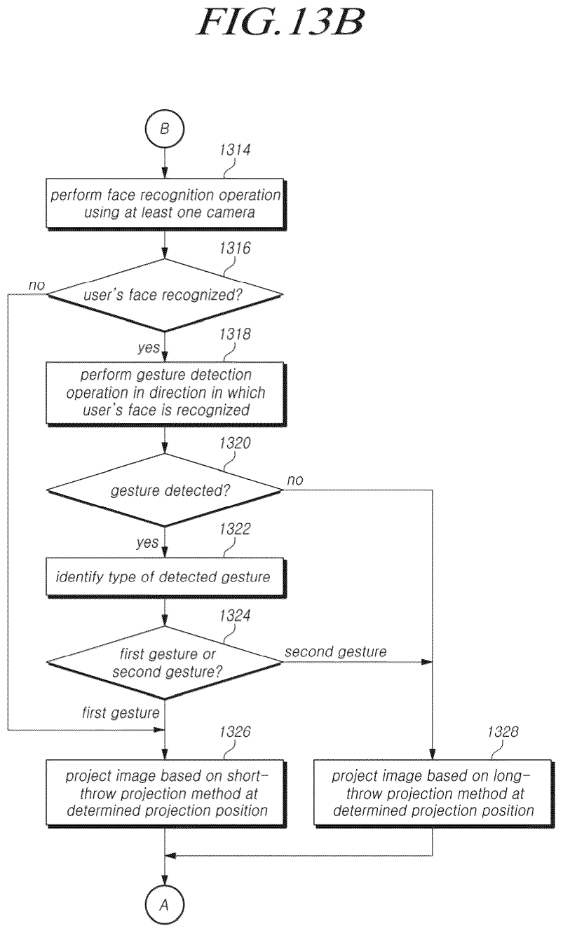

Hereinafter, an operation in which the mobile projector 100 determines a projection method for the operation of the extension display device is described with reference to FIGS. 13A and 13B. According to one or more embodiments, the operations illustrated in FIGS. 13A and 13B may be operations related to operation 308 of FIG. 3, and may be operations performed based on the determination of the projection position.

According to one or more embodiments, a projection method that may be used if the mobile projector 100 is set as an extension display device may include a first projection method and/or a second projection method. The first projection method may include a method using the first projection lens (e.g., a short-throw projection lens) 131, and the second projection method may include a method using the second projection lens (e.g., a long-throw projection lens). The first projection method may be a method having a shorter projection distance or focal length than the second projection method. For convenience of description, hereinafter, the first projection method is referred to as a short-throw projection method, and the second projection method will be referred to as a long-throw projection method.

FIG. 13A is a flowchart illustrating an operation in which a mobile projector determines a projection method based on a change in height and whether there is a fall section according to one or more embodiments.

Referring to FIG. 13A, in operation 1302, the mobile projector 100 may periodically or aperiodically measure the height (or altitude) of the mobile projector 100 from a specific point (e.g., floor) using the inertial sensor 141 at the determined projection position. According to one or more embodiments, the determined projection position may be a projection position determined in operation 306 of FIG. 3 (e.g., a position determined based on position information about the source device 200), a projection position determined in operation 1106 of FIG. 11 (e.g., a position where the source device 200 is present), or a projection position determined in operation 1112 (e.g., a position where the user is discovered).

In operation 1304, the mobile projector 100 may determine whether there is a height change (or a height change) of the mobile projector 100 based on the height measurement result. The height change of the mobile projector 100 may be generated by the user at the projection position. For example, a change in the height of the mobile projector 100 may occur based on the user lifting the mobile projector 100 at the projection position or the user placing the mobile projector 100 on the floor on a table (or desk).

The mobile projector 100 may project an image based on the long-throw projection method at the determined projection position of the mobile projector 100 based on there being no change in the height of the mobile projector 100, in operation 1312.

In operation 1306, the mobile projector 100 may detect the surrounding environment of the mobile projector 100 using the distance sensor 142 and/or at least one camera (e.g., the RGB camera 151 and/or the depth camera 152) included in the camera assembly 150 based on there being a change in the height of the mobile projector 100.

In operation 1308, the mobile projector 100 may determine whether a fall section is present based on the detection result of the surrounding environment. According to one or more embodiments, the fall section may indicate a section or a point where the mobile projector 100 may fall. For example, the fall section may include a stair, a step, or a point where there is a sudden change in height.

The mobile projector 100 may project an image based on the short-throw projection method at the determined projection position of the mobile projector 100 based on the absence of the fall section in operation 1310.

The mobile projector 100 may perform operation 1314 of FIG. 13B connected by the symbol B based on the presence of the fall section.

FIG. 13B is a flowchart illustrating an operation in which a mobile projector determines a projection method based on a result of user face recognition and gesture detection according to one or more embodiments.

Referring to FIG. 13B, the mobile projector 100 may perform a face recognition operation using at least one camera in operation 1314, based on the presence of the fall section.

In operation 1316, the mobile projector 100 may determine whether the user's face is recognized based on the face recognition operation. According to one or more embodiments, the mobile projector 100 may determine whether the user's face is recognized based on previously stored user's face information.

The mobile projector 100 may project an image based on the short-throw projection method at the determined projection position of the mobile projector 100, based on the user's face being not recognized, in operation 1326.

The mobile projector 100 may perform a gesture detection operation in a direction in which the user's face is recognized, in operation 1318, based on the user's face being recognized.

In operation 1320, the mobile projector 100 may determine whether the user's gesture is detected based on the gesture detection operation.

Based on the user's gesture being not detected, the mobile projector 100 may project an image based on the long-throw projection method at the determined projection position of the mobile projector 100, in operation 1328.

The mobile projector 100 may identify the type of the detected gesture in operation 1322, based on the user's gesture being detected.

In operation 1324, the mobile projector 100 may determine whether the type of the identified gesture is a first gesture or a second gesture. According to one or more embodiments, the first gesture may include a gesture in which the user points her hand (or finger) at the floor, and the second gesture may include a gesture in which the user points her hand (or finger) at the wall.

The mobile projector 100 may project an image based on the long-throw projection method at the determined projection position of the mobile projector 100 based on the identified gesture type being the first gesture, in operation 1326.

The mobile projector 100 may project an image based on the long-throw projection method at the determined projection position of the mobile projector 100 based on the identified gesture type being the second gesture, in operation 1328.

After performing operation 1326 or 1328, the mobile projector 100 may again perform operation 1302 of FIG. 13A connected by the symbol A.

According to one or more embodiments, the mobile projector 100 may receive the user's input (or command) during image projection. For example, the mobile projector 100 may receive the user's input through the UI 170.

If the control signal generated based on interaction with the UI 170 includes information instructing to project an image different from the image being projected, the mobile projector 100 may stop projecting the image and release the setting of the mobile projector 100 as the extension display device. Alternatively, the mobile projector 100 may disregard the control signal, maintain the setting of the extension display device, and continue projecting the image according to the user's setting.

If the control signal generated based on interaction with the UI 170 includes information instructing to move, the mobile projector 100 may stop the projection operation, release the setting of the mobile projector 100 as the extension display device, or stop the operation of the extension display device.

The mobile projector 100 may perform an operation different from the foregoing according to operation priority.

According to one or more embodiments, the projection method for each condition based on the operations illustrated in FIGS. 13A and 13B may be as shown in Table 1 below.

TABLE 1

| | | | | (first gesture) short- |
|---|---|---|---|---|
| | | | | throw projection |
| | | | | method |
| | | | | (second gesture) |
| Presence of change | Presence of fall | Recognition of user | Detection of | long-throw |
| in height | section | face | gesture | projection method |
| | | | Non-detection of | Long-throw |
| | | | gesture | projection method |
| | | Non-recognition of | Short-throw | — |
| | | user's face | projection method | |
| | no fall section | Short-throw | — | — |
| | | projection method | | |
| No change in | Long-throw | — | — | — |
| height | projection method | | | |

Referring to Table 1, the mobile projector 100 may use the long-throw projection method based on there being no change in the height of the mobile projector 100.

The mobile projector 100 may use the short-throw projection method based on the presence of a change in the height of the mobile projector 100 and the absence of the fall section.

The mobile projector 100 may use the short-throw projection method based on the presence of a change in height of the mobile projector 100, the presence of a fall section, and non-recognition of the user's face.

The mobile projector 100 may use the long-throw projection method based on the presence of a change in height of the mobile projector 100, the presence of the fall section, recognition of the user's face, and non-detection of the user's gesture.

The mobile projector 100 may use the short-throw projection method based on the presence of a change in height of the mobile projector 100, the presence of the fall section, recognition of the user's face, detection of the user's gesture, and identification of the detected gesture as the first gesture.

The mobile projector 100 may use the long-throw projection method based on the presence of a change in height of the mobile projector 100, the presence of the fall section, recognition of the user's face, detection of the user's gesture, and identification of the detected gesture as the second gesture.

According to one or more embodiments, conditions that may be used for determining a projection method (e.g., whether there is a change in the height of the mobile projector 100, whether there is a fall section, whether the user's face is recognized, whether a gesture is detected, or the type of a detected gesture) may be used individually or in combination of at least two thereof. For example, the projection method may be determined by a combination of whether there is a change in the height of the mobile projector 100 and whether there is a fall section. In this case, the condition of whether the user's face is recognized or the type of the detected gesture may not be used. If a combination of whether there is a change in the height of the mobile projector 100 and whether there is a fall section is used, the mobile projector 100 may use the long-throw projection method based on the presence of a change in the height of the mobile projector 100 and the presence of the fall section.

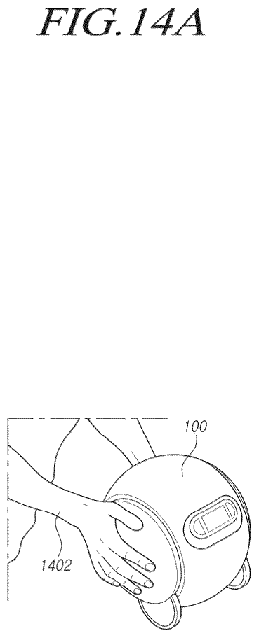

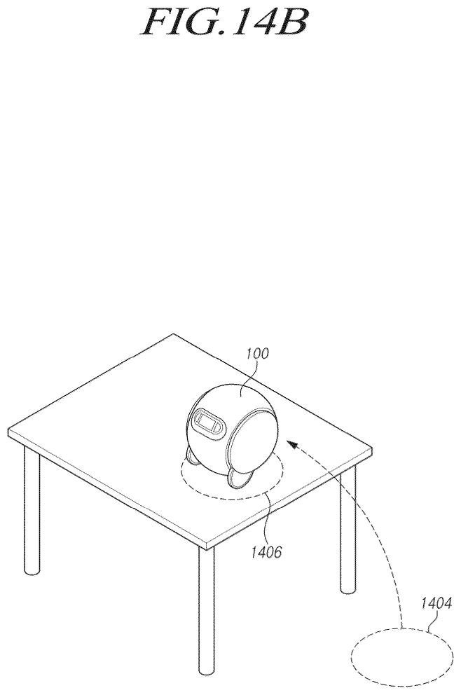

FIGS. 14A and 14B are diagrams illustrating an example of a circumstance in which a height of a mobile projector is changed according to one or more embodiment.

Referring to FIGS. 14A and 14B, the height of the mobile projector 100 from the corresponding position may be changed by the user 1402. For example, as shown in FIG. 14A, if the user 1402 lifts the mobile projector 100, the height of the mobile projector 100 may be changed. As another example, as shown in FIG. 14B, if the user places the mobile projector 100 positioned on the floor 1404 on the table 1406, the height of the mobile projector 100 may be changed. The mobile projector 100 may detect the change in the height of the mobile projector 100 using the inertial sensor 141.

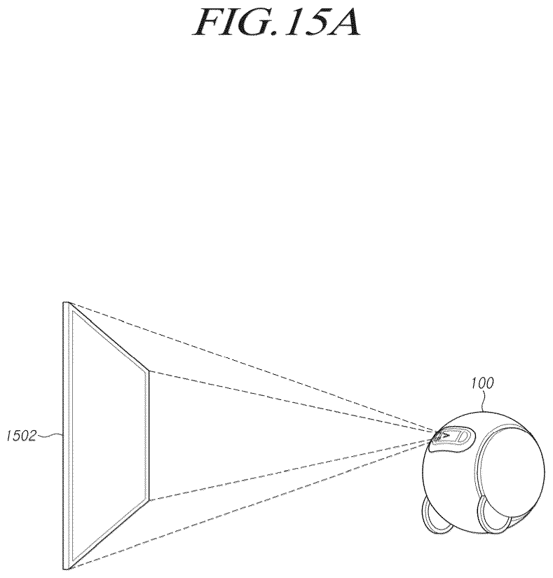

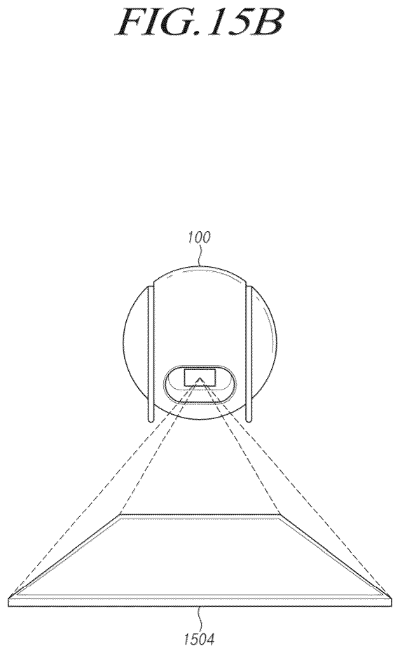

FIG. 15A is a diagram illustrating a long-throw projection method according to one or more embodiments.

Referring to FIG. 15A, the mobile projector 100 may project an image based on the long-throw projection method. The mobile projector 100 may use a second projection lens (e.g., the long-throw projection lens) 132 for the long-throw projection method. The mobile projector 100 may control the main body 101 to indicate an angle or direction for the long-throw projection method.

According to one or more embodiments, the angle or direction corresponding to the long-throw projection method may be used as an initial set angle or initial set direction (or a basic angle or basic direction, or a default angle or default direction) of the mobile projector 100.

According to one or more embodiments, the mobile projector 100 may project an image to an area (or a plane) spaced apart from the mobile projector 100 such as a wall surface or a screen 1502, based on the long-throw projection method.

FIG. 15B is a diagram illustrating a short-throw projection method according to one or more embodiments.

Referring to FIG. 15B, the mobile projector 100 may project an image based on the short-throw projection method. The mobile projector 100 may use a first projection lens (e.g., the short-throw projection lens) 131 for the short-throw projection method. The mobile projector 100 may control the main body 101 to indicate an angle or direction for the short-throw projection method.

According to one or more embodiments, the mobile projector 100 may set an angle or direction for the short-throw projection method by rotating the main body 101 from the initial set angle (e.g., 0 degrees from the axis parallel to the floor) to a preset direction (e.g., −y-axis direction or counterclockwise direction).

According to one or more embodiments, the mobile projector 100 may project an image to the area (or the plane) positioned adjacent to the mobile projector 100 such as the floor surface 1504 based on the short-throw projection method.

According to one or more embodiments, the projection distance corresponding to the short-throw projection method may be shorter than the projection distance corresponding to the long-throw projection method.

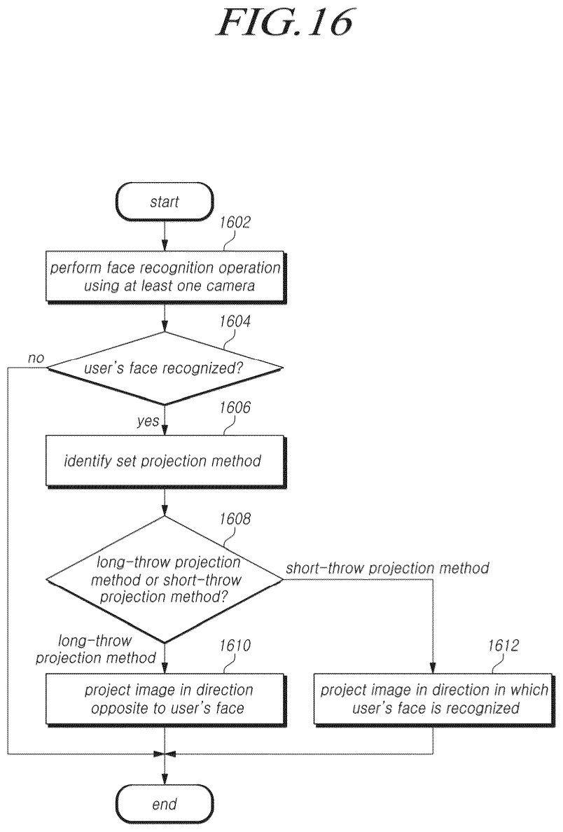

FIG. 16 is a flowchart illustrating an operation in which a mobile projector projects an image considering a direction in which a user's face is recognized according to one or more embodiments.

According to one or more embodiments, the operations illustrated in FIG. 16 may be performed based on the projection method of the mobile projector 100 being set, and may be performed for the operation of the extension display device. For example, the set projection method may correspond to the projection method determined based on the operations of FIGS. 13A and/or 13B.

Referring to FIG. 16, in operation 1602, the mobile projector 100 may perform a face recognition operation using at least one camera.

In operation 1604, the mobile projector 100 may determine whether the user face is recognized based on a result of performing the face recognition operation.

The mobile projector 100 may terminate the operation or project an image based on the set projection method based on the user's face being not recognized.

The mobile projector 100 may identify the set projection method in operation 1606, based on the recognition of the user's face.

In operation 1608, the mobile projector 100 may determine whether the identified projection method is the long-throw projection method or the short-focus projection method.

In operation 1610, the mobile projector 100 may project an image from a direction opposite to the user's face based on the identified projection method being the long-throw projection method.

In operation 1612, the mobile projector 100 may project an image in a direction in which the user's face is recognized based on the identified projection method being the long-throw projection method.

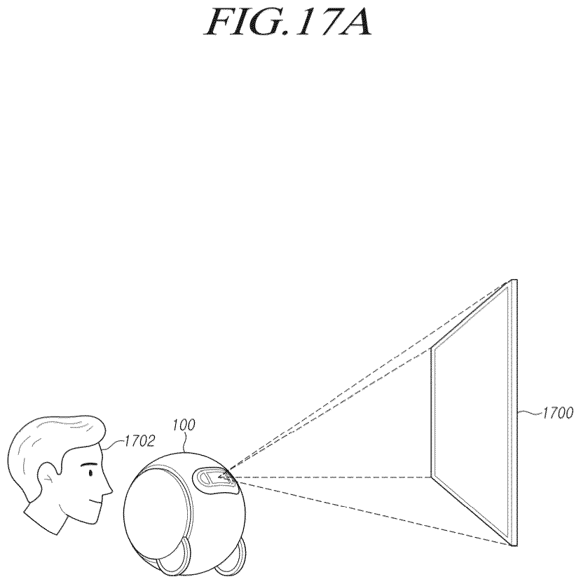

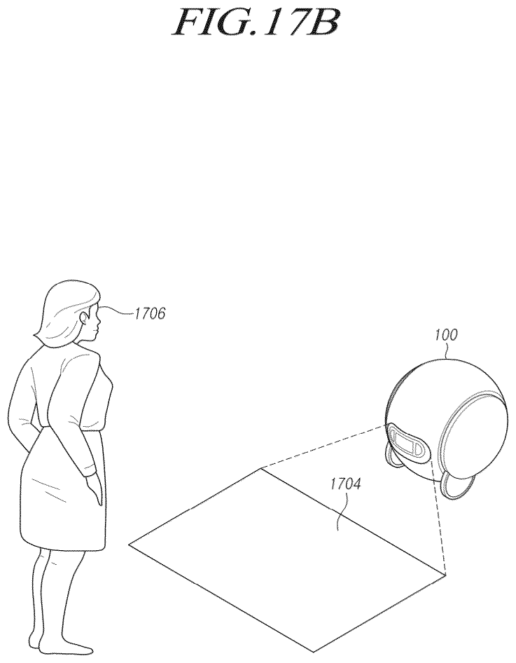

FIG. 17A is a diagram illustrating an operation in which a mobile projector projects an image from a direction opposite to a user's face according to one or more embodiments.

FIG. 17A illustrates operations of the mobile projector 100 that may be performed in operation 1610 of FIG. 16. If the mobile projector 100 uses the long-throw projection method, the mobile projector 100 may project an image from the direction opposite to the user face 1702 so that the image is not projected on the user face 1702. For example, the mobile projector 100 may project an image into an area 1700 opposite to the user's face 1702 so that the image is projected in the direction in which the user's gaze faces. The mobile projector 100 may project an image by controlling the main body 101 to have an angle (e.g., the initial set angle) corresponding to the long-throw projection method.

FIG. 17B is a diagram illustrating an operation in which a mobile projector projects an image from a direction in which a user's face is recognized according to one or more embodiments.

FIG. 17B illustrates operations of the mobile projector 100 that may be performed in operation 1612 of FIG. 16. If the mobile projector 100 uses the short-throw projection method, the mobile projector 100 may project an image in a direction in which the user face 1702 is recognized. The mobile projector 100 may project an image by controlling the main body 101 to have an angle corresponding to the short-throw projection method (e.g., an angle rotated by 45 degrees in the −y-axis direction from the initial set angle). Since the projection angle corresponding to the short-throw projection method may face the bottom surface 1704, the image may not be projected onto the user's face 1706.

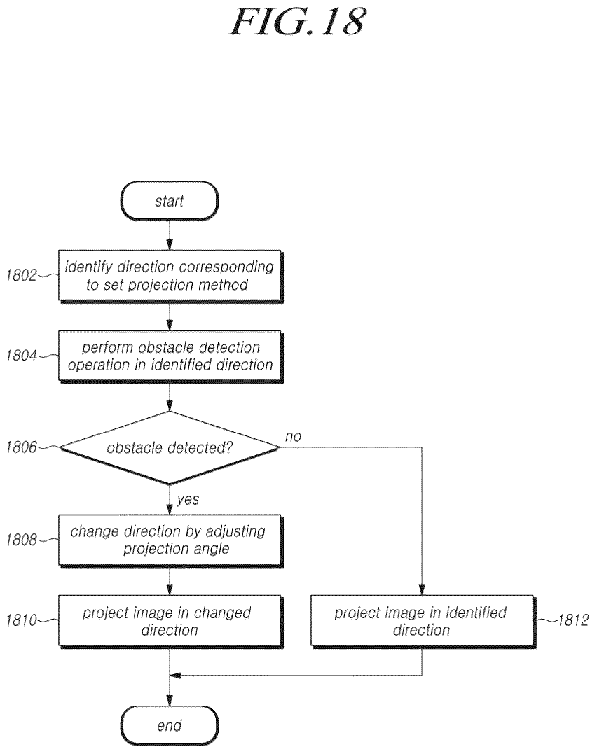

FIG. 18 is a flowchart illustrating an operation in which a mobile projector projects an image based on an obstacle detection result according to one or more embodiments.

According to one or more embodiments, the operations illustrated in FIG. 18 may be performed based on the projection method of the mobile projector 100 being set, and may be performed for the operation of the extension display device. For example, the set projection method may correspond to the projection method determined based on the operations of FIGS. 13A and/or 13B.

In operation 1802, the mobile projector 100 may identify a direction corresponding to the set projection method. For example, in the mobile projector 100, the first direction corresponding to the long-throw projection method may correspond to the first angle corresponding to the long-through projection method, and the second direction corresponding to the short-throw projection method may correspond to the second angle corresponding to the short-throw projection method. The first angle and/or the second angle may be determined based on the initial set angle and/or rotation angle of the main body 101.

In operation 1804, the mobile projector 100 may perform an obstacle detection operation in the identified direction. According to one or more embodiments, the mobile projector 100 may perform an obstacle detection operation of analyzing the projection area (or the projection surface) corresponding to the identified direction using at least one camera. For example, the mobile projector 100 may perform an obstacle detection operation that analyzes the projection area based on a plane detection operation or an object (obstacle) detection operation using a computer vision algorithm.

In operation 1806, the mobile projector 100 may determine whether an obstacle is detected on the projection area based on the result of performing the obstacle detection operation. For example, the obstacle may include a person, a thing, an animal, or a structure.

Based on the detection of an obstacle on the projection area, the mobile projector 100 may change the direction by adjusting the projection angle in operation 1808. According to one or more embodiments, the projection angle may be adjusted based on the rotation of the main body 101.

In operation 1810, the mobile projector 100 may project an image in a changed direction.

Based on no obstacle being detected on the projection area, the mobile projector 100 may project an image in the identified direction in operation 1812.

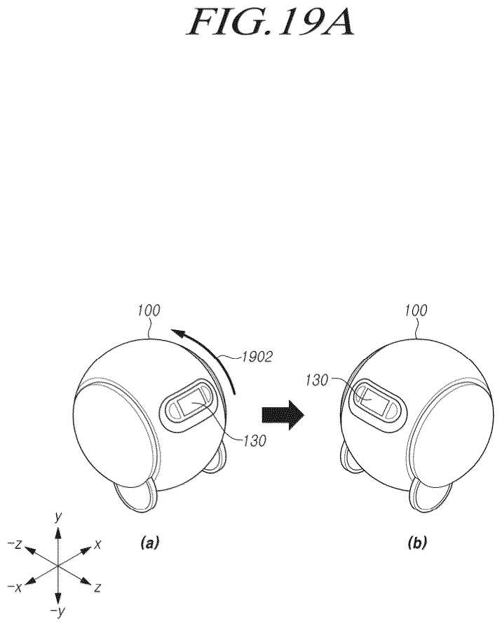

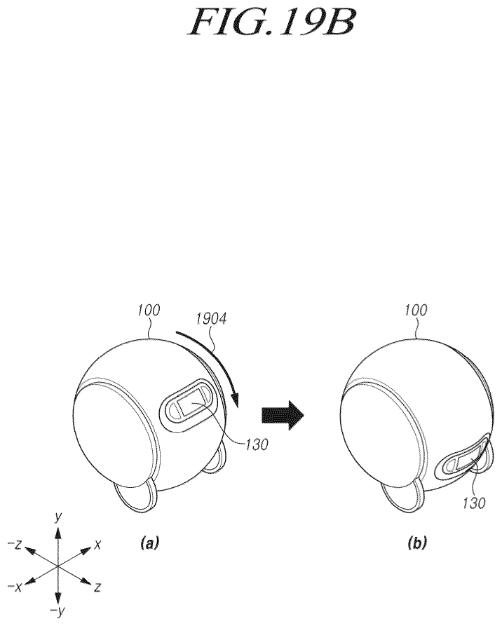

FIG. 19A is a diagram illustrating an operation in which a mobile projector changes a projection angle for long-throw projection according to one or more embodiments.

Referring to FIG. 19A, the mobile projector 100 may perform long-throw projection using the long-throw projection method at the initial set angle. If it is detected that the user or the user's face is present or an obstacle is present in the projection direction (or the projection area), the mobile projector 100 may rotate the main body 101 to change the projection angle.

According to one or more embodiments, as shown in (a) of FIG. 19A, the mobile projector 100 may rotate the main body 101 by a preset angle (e.g., an angle between 0 and 90 degrees) in a positive direction of an axis (e.g., y-axis) orthogonal to the floor surface (1902).

According to one or more embodiments, as shown in (b) of FIG. 19A, the position of the projector 130 may be changed based on the rotation of the main body 101, and the projection direction or angle may be changed based on the changed position of the projector 130.

FIG. 19B is a diagram illustrating an operation in which a mobile projector changes a projection angle for short-throw projection according to one or more embodiments.

Referring to FIG. 19B, the mobile projector 100 may rotate the main body 101 to perform short-throw projection while performing long-throw projection at the initial set angle.

According to one or more embodiments, as shown in (a) of FIG. 19B, the mobile projector 100 may rotate the main body 101 by a preset angle (e.g., an angle between 0 and 45 degrees) in a negative direction of an axis (e.g., y-axis) orthogonal to the floor surface (1904).

According to one or more embodiments, as shown in (b) of FIG. 19B, the position of the projector 130 may be changed based on the rotation of the main body 101, and the projection direction or angle may be changed to the projection direction or angle for short-throw projection based on the changed position of the projector 130.

According to one or more embodiments, if it is detected that the user or the user's face is present or an obstacle is present in the projection direction (or the projection area) for short-throw projection, the mobile projector 100 may rotate the main body 101 to change the projection angle. For example, the mobile projector 100 may rotate the main body 101 by a preset angle (e.g., an angle between 0 and 10 degrees) in a positive direction or negative direction of an axis (e.g., y-axis) orthogonal to the floor surface.

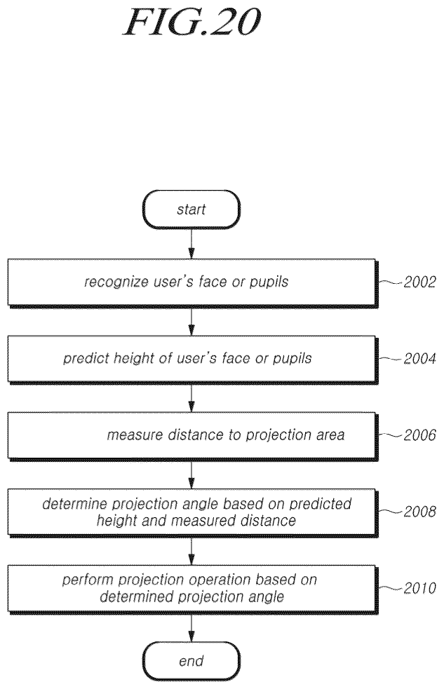

FIG. 20 is a flowchart illustrating an operation in which a mobile projector performs a projection operation based on a user's face or gaze according to one or more embodiments.

According to one or more embodiments, the operations illustrated in FIG. 20 may be performed based on the user being recognized by the mobile projector 100, and may be performed for the operation of the extension display device. According to one or more embodiments, the mobile projector 100 may know the height of the mobile projector 100 and the position of the projector 130 or the second projection lens 132 in advance.

Referring to FIG. 20, in operation 2002, the mobile projector 100 may recognize the user's face or pupils using at least one camera included in the camera assembly 150.

In operation 2004, the mobile projector 100 may predict the height of the user's face or pupils. For example, the mobile projector 100 may predict the height of the user's face or pupils based on the distance sensor 142 and/or at least one camera.

In operation 2006, the mobile projector 100 may measure the distance from the projection area (or the projection surface). For example, the mobile projector 100 may measure the distance between the mobile projector 100 and the projection area using the distance sensor 142.

In operation 2008, the mobile projector 100 may determine the projection angle based on the predicted height and the measured distance.

In operation 2010, the mobile projector 100 may perform the projection operation based on the determined projection angle. For example, the mobile projector 100 may rotate the main body 101 to correspond to the projection angle and then project an image onto the projection area.

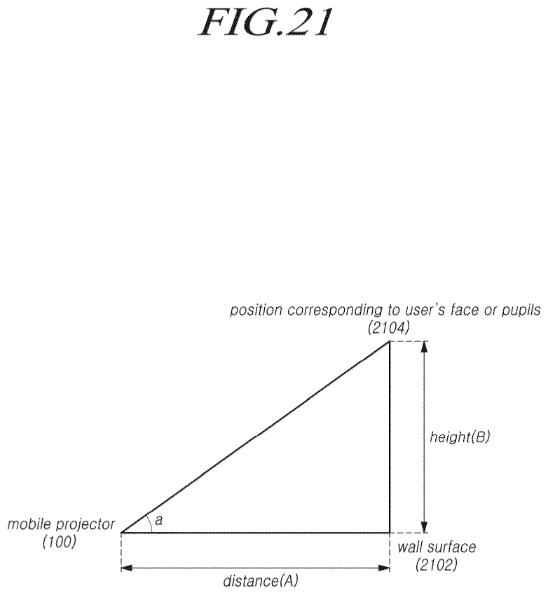

FIG. 21 is a diagram illustrating an operation in which a mobile projector determines a projection angle according to one or more embodiments.

Referring to FIG. 21, if the mobile projector 100 uses the long-throw projection method, the projection area may be a wall surface 2102. The mobile projector 100 may measure a distance A from the wall surface 2102.

The mobile projector 100 may recognize the user's face or pupils. The mobile projector 100 may measure the distance from the position of the wall surface 2102, distance A away from the mobile projector 100, to the position 2104 corresponding to the user's face or pupils, as a height B.

The mobile projector 100 may determine the projection angle a using the inverse function of the triangular function based on the distance A and the height B. For example, the mobile projector 100 may determine the projection angle a using the following Equation (1).

$$a = arc cos ( \frac{A}{\sqrt{{A}^{2} + {B}^{2}}} ) = arc sin ( \frac{A}{\sqrt{{A}^{2} + {B}^{2}}} ) \qquad ( 1 )$$

The mobile projector 100 may rotate the main body 101 based on the determined projection angle a and then project an image onto the wall surface 2102. The image projected onto the wall surface 2102 may correspond to the user's gaze.

According to various embodiments of the disclosure, since the mobile projector 100 may be used as an extension display device in an indoor space (e.g., in the house), a more effective user experience may be obtained. For example, the mobile projector 100 may move to a place where the user or source device 200 is positioned and project images of various contents wherever it is positioned in the indoor space. The mobile projector 100 may determine the projection position by recognizing the current position of the mobile projector 100, a change in the circumstance of the mobile projector 100 (e.g., a change in altitude or height), surrounding environment information (e.g., whether it is in a fallible place), or the user's face or gesture, thereby enhancing the user experience for the extension display device.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A mobile projector device, comprising:
a drive assembly comprising at least one wheel;
a transceiver;
a projector;
memory storing instructions; and
at least one processor,
wherein the instructions, when executed by the at least one processor, cause the mobile projector device to:
determine whether to set the mobile projector device as an extension display device associated with a source device;
receive, through the transceiver and from the source device, information about an image based on determining to set the mobile projector device as the extension display device;
determine a projection position for projecting the image based on position information about the source device; and
control the projector to project the image at the projection position.

2. The mobile projector device of claim 1, wherein the instructions, when executed by the at least one processor, further cause the mobile projector device to:
receive, through the transceiver and from the source device, a request message requesting to set the mobile projector device as the extension display device;
determine whether a projection operation by the projector is being performed based on reception of the request message;
based on determining that the projection operation is being performed, determine to not set the mobile projector device as the extension display device, and control the transceiver to transmit a reject message to the source device; and
based on determining that the projection operation is not being performed, determine to set the mobile projector device as the extension display device and control the transceiver to transmit an accept message to the source device.

3. The mobile projector device of claim 1, wherein the instructions, when executed by the at least one processor, further cause the mobile projector device to:
control the drive assembly to move the mobile projector device to the projection position.

4. The mobile projector device of claim 1, wherein the instructions, when executed by the at least one processor, further cause the mobile projector device to, while at the projection position:
identify an area adjacent to the source device; and
control the projector to project the image to the identified area.

5. The mobile projector device of claim 1, further comprising a user interface (UI),
wherein the instructions, when executed by the at least one processor, further cause the mobile projector device to:
identify a control signal generated based on interaction with the UI; and
based on the identified control signal, stop projecting the image and release the setting of the mobile projector device as the extension display device, and
wherein the identified control signal comprises information instructing to project a different image or information instructing to move the mobile projector device.

6. The mobile projector device of claim 1, wherein the information about the image comprises information about at least one of:
an image received in real-time by the source device,
an image associated with an application executed on the source device,
an image associated with a camera connected to the source device, and
an image provided from a mobile terminal connected to the source device.

7. The mobile projector device of claim 1, further comprising:
a main body;
a driver;
a plurality of sensors; and
at least one camera,
wherein the instructions, when executed by the at least one processor, further cause the mobile projector device to:
determine, by the plurality of sensors and/or the at least one camera, a presence or absence of an obstacle in a direction in which the image is projected; and
based on determining the presence of the obstacle, control the driver to rotate the main body of the mobile projector device by a predetermined angle.

8. The mobile projector device of claim 1, further comprising:
a plurality of sensors; and
at least one camera,
wherein the instructions, when executed by the at least one processor, further cause the mobile projector device to:
determine, by a first sensor among the plurality of sensors, a presence or absence of a change in height at the projection position;
based on determining the presence of the change in height:
determine, by at least one of a second sensor among the plurality of sensors and the at least one camera, a presence or absence of a fall section at a position adjacent to the mobile projector device, the fall section indicating an area where the mobile projector device will fall; and
based on determining the absence of the fall section, control the projector to project the image using a first projection method; and
based on determining the absence of the change in height:
control the projector to project the image using a second projection method, and
wherein the first projection method and the second projection method differ in projection distance or projection direction.

9. The mobile projector device of claim 8, wherein the instructions, when executed by the at least one processor, further cause the mobile projector device to, based on determining the presence of the fall section:
perform, by the at least one camera, a face recognition operation;
determine whether a user's face is recognized based on the face recognition operation; and
based on the user's face not being recognized, control the projector to project the image using the first projection method.

10. The mobile projector device of claim 8, wherein the instructions, when executed by the at least one processor, further cause the mobile projector device to, based on determining the presence of the fall section:
perform, by the at least one camera, a face recognition operation;
determine whether a user's face is recognized based on the face recognition operation; and
based on the user's face being recognized:
determine, by the at least one camera and in a direction in which the user's face is recognized, whether the user's gesture is detected;
based on the user's gesture being detected:
identify whether the user's gesture is a first gesture or a second gesture;
control the projector to project the image using the first projection method based on the user's gesture being the first gesture; and
control the projector to project the image using the second projection method based on the user's gesture being the second gesture; and
based on the user's gesture being not detected, control the projector to project the image using the second projection method.

11. A method for operating a mobile projector device, the method comprising:
determining whether to set the mobile projector device as an extension display device associated with a source device;
receiving information about an image from the source device based on determining to set the mobile projector device as the extension display device;
determining a projection position for projecting the image based on position information about the source device; and
projecting the image at the projection position.

12. The method of claim 11, wherein the determining whether to set the mobile projector device as the extension display device comprises:
receiving, from the source device, a request message for requesting to set the mobile projector device as the extension display device;
determining whether a projection operation is being performed based on reception of the request message;
based on determining that the projection operation is being performed, determining to not set the mobile projector device as the extension display device, and transmitting a reject message to the source device; and
based on determining that the projection operation is not being performed, determining to set the mobile projector device as the extension display device and transmitting an accept message to the source device.

13. The method of claim 11, further comprising controlling a drive assembly of the mobile projector device to move the mobile projector device to the projection position.

14. The method of claim 11, wherein the projecting the image comprises:
identifying an area adjacent to the source device; and
projecting the image to the identified area.

15. The method of claim 11, further comprising:
identifying a control signal generated based on interaction with a user interface (UI) of the mobile projector device; and
based on the identified control signal, stopping projecting the image and releasing the setting of the mobile projector device as the extension display device,
wherein the identified control signal comprises information instructing to project a different image or information instructing to move the mobile projector device.

16. The method of claim 11, wherein the information about the image comprises information about at least one of:
an image received in real-time by the source device,
an image associated with an application executed on the source device,
an image associated with a camera connected to the source device, and
an image provided from a mobile terminal connected to the source device.

17. The method of claim 11, further comprising:
determining, by at least one of a plurality of sensors or at least one camera of the mobile projector device, a presence or an absence of an obstacle in a direction in which the image is projected; and
based on determining the presence of the obstacle, changing the direction in which the image is projected by rotating a main body of the mobile projector device by a predetermined angle.

18. The method of claim 11, wherein projecting the image comprises:
determining, by a first sensor among a plurality of sensors of the mobile projector device, a presence or absence of a change in height at the projection position;
based on determining the presence of the change in height:
determining, by at least one of a second sensor among the plurality of sensors and at least one camera of the mobile projector device, a presence or absence of a fall section at a position adjacent to the mobile projector device, the fall section indicating an area where the mobile projector device will fall; and
projecting the image using a first projection method based on determining the absence of the fall section; and
based on determining the absence of the change in height, projecting the image using a second projection method, and
wherein the first projection method and the second projection method differ in projection distance or projection direction.

19. The method of claim 18, further comprising:
based on determining the presence of the fall section, performing, by the at least one camera, a face recognition operation;
determining whether a user's face is recognized based on the face recognition operation; and
based on the user's face not being recognized, projecting the image using the first projection method.

20. The method of claim 18, further comprising:
based on determining the presence of the fall section, performing, by the at least one camera, a face recognition operation;
determining whether a user's face is recognized based on the face recognition operation;
based on the user's face being recognized:
determining, by the at least one camera and in a direction in which the user's face is recognized, whether the user's gesture is detected; and
based on the user's gesture being detected:
identifying whether the user's gesture is a first gesture or a second gesture;
projecting the image using the first projection method based on the user's gesture being the first gesture; and
projecting the image using the second projection method based on the user's gesture being the second gesture; and
based on the user's gesture not being detected, projecting the image using the second projection method.
